(19) United States
(12) Patent Application Publication
(10) Pub. No.: US 2006/0106539 A1
(43) Pub. Date: May 18, 2006

(54) System and method for electronically recording task-specific and location-specific information, including farm-related information

(76) Inventors: Paul H. Choate, Murray, KY (US); Aaron A. Wallace, Murray, KY (US)

Correspondence Address: HEIMBECHER & ASSOC., LLC., 6125 SALVIA LANE, ARVADA, CO, 80403, US

(21) Appl. No.: 10/987,925

(22) Filed: Nov. 12, 2004

(51) Int. Cl. G01V 7/00

(52) U.S. Cl. 702/2

(57) ABSTRACT

A system and method for electronically tracking and recording task-specific and location-specific information, including farming-related information, agricultural information, and other information. The system and method comprise a handheld unit having a simple-to-use, fully-customizable user interface that a farmer, for example, can carry with him during his daily tasks. Since the farmer is able to record agricultural-related information on the fly, the system and method facilitate the collection and compilation of highly-accurate information concerning the details of the farming operation. The information that is collected may be used, for example, in complying with various governmental rules and regulations.

### BACKGROUND OF THE INVENTION

a. Field of the Invention

The instant invention is directed toward a system and method for electronically tracking and recording task-specific and location-specific information. More specifically, it relates to a system and method comprising mobile devices with touchscreen displays for electronically tracking, recording, and analyzing agricultural and other farming-related data.

b. Background Art

It is well known that being able to track and record data in a simple way that facilitates quick and accurate recall is key to making efficient use of the variety of information that is available to us. This is true in many industries, including the agricultural industry. For example, farmers traditionally have worked long hours in their fields tending to their crops and then, upon returning home at night, have been required to record a variety of information in journals, and on various forms, charts, graphs, whether in paper format or on the farmer's personal computer (PC). Among the wealth of information that farmers track during the operation of a farm are data related to the following: soil types; crop types; farming operations such as tilling, fertilizing, planting, cultivating, spraying, and harvesting; chemical types that have been applied such as fertilizers and herbicides; and diseases and pest types that are encountered and ways of dealing with them. Farmers frequently must also keep track of visual observations made as the farmer inspects and works the fields. Not only is it important for the farmer to make observations about particular parts of his fields, but also to record the geographic location where those observations are made or to which they pertain. Recording information by location makes it easier for the farmer to quickly recall only the observations that are relevant to a specific field, and to quickly review and analyze those operations.

Further, as governmental agencies, such as the Environmental Protection Agency (EPA), have put more and more restrictions and controls on farmers, the amount of data that each farmer must track in order to comply with his government reporting requirements has ballooned. On the positive side, the government also provides a variety of opportunities for farmers to participate in beneficial farming programs and conservation programs, for example, and to obtain funds from the government, as long as the farmer is able to provide the information requested for participation. In order to assist farmers with their data collection, tracking, and reporting requirements, whether undertaken to meet compliance reporting requirements or to take advantage of business opportunities, a number of systems have been created.

Among the existing systems designed to facilitate a farmer's data collection and tracking is the SST Stratus software and hardware produced by SST Development Group, Inc. (www.sstdevgroup.com). Another product that is currently on the market that facilitates the tracking of farming information is Farm Trac+ and Farm Trac Mate, which are available from Farm Works Software (www.farmworks.com), a division of CTN Data Service, Inc. Another existing product is called Pocket Dairy™. In addition to these and other products that are on the market, there are a few patents directed toward computer networks and handheld computers, pocket computers, or personal digital assistants (PDAs) for collecting and analyzing agronomic data, including U.S. Pat. No. 5,566,069 (the '069 patent) and U.S. Pat. No. 5,699,244 (the '244 patent).

In the '069 patent, the farmer has two computers, a “field” or portable computer as well as a “fixed” platform PC (e.g., in the farmer's house) that may be connected to a third (server) computer or a network of other computers. The field computer may be a PDA with a graphic user interface (GUI) and a built-in global positioning system (GPS) receiver for sophisticated mapping, navigational, and positioning functions to facilitate location-specific data collection. The PC in the farmer's house stores large amounts of information to prevent overload of the memory or processor capabilities, for example, of the portable computer. The farmer then selects the particular data to be downloaded from the PC and stored in the portable computer. Alternatively, data may be downloaded from the PC to a memory card that may be inserted into the portable computer. In the '244 patent, which issued from a continuation-in-part of the application that issued as the '069 patent, additional features and functions were added to the system disclosed in the '069 application. With the systems disclosed in the '069 patent and the '244 patent, after the farmer collects the data in the field, the farmer must download that collected information to the fixed platform PC for further manipulation. These prior art devices require a computer literate user, training, and a relatively substantial learning curve to be used effectively.

Although some of these existing systems take advantage of GUIs, these existing systems remain needlessly complex and are thus relatively difficult to use effectively. Thus, for various reasons, these existing systems unfortunately have not provided the best solution for the problems encountered by farmers. The existing systems are, for example, either extremely complex to use, having a relatively long and undesirable time-to-competence (i.e., are too complex to use), or they provide insufficient data collection capabilities (i.e., may be relatively simple to use, but are too simplistic in their data collection capabilities). Thus, there remains a need for a powerful system that is simple and intuitive to use for electronically recording agronomical data efficiently, on-the-fly or on-the-spot in the field, by any user, regardless of skill level, education, or level of computer literacy.

### BRIEF SUMMARY OF THE INVENTION

It is desirable to be able to collect agricultural and other information in a simple and efficient manner. Farm laborers know where they are and what they are doing. What they need is a simple and intuitive system to record information about the tasks they perform—information that they or someone else needs to know after the fact for reporting and other purposes. Accordingly, it is an object of the disclosed invention to provide an improved system and method for collecting agronomical and other data.

In a first form, the instant invention comprises a pocket computer for electronically storing farming-related information for a data point-of-origin such as a selected field. In this form, the pocket computer comprises a memory for storing the farming-related information, and a resident computer program to control a graphical user interface that generates a plurality of touchscreens to facilitate receipt and storage of the farming-related information into the memory. The resident computer program is adapted to store the farming-related information based upon user inputs received through the graphical user interface. At least a subset of the plurality of touchscreens generated by the graphical user interface comprises the farming-related information overlaid onto an image (e.g., aerial photograph) of the selected field. The pocket computer may further comprise at least one of a camera, a microphone, a keypad, a wireless modem, and a telephone. The plurality of touchscreens may comprise at least one activity touchscreen for selecting a farming-related activity and/or at least one operation touchscreen for selecting a farming-related operation.

In another form, the present invention comprises a handheld device for electronically storing and, optionally, processing task-specific data for a particular task. In this form, the handheld device comprises a memory for storing the task-specific data, and a resident computer program to control a graphical user interface that generates a plurality of touchscreens to facilitate receipt and storage of the task-specific data into the memory. The resident computer program is adapted to store and manipulate the task-specific data based upon user inputs received through the graphical user interface, and the graphical user interface presents a notes icon for accessing note-taking capabilities.

In still another form, the present invention comprises a handheld device for electronically storing data for a point-of-origin (e.g., a farmer-selected field). In this form, the handheld device comprises a memory for storing the data, and a resident computer program to control a graphical user interface that generates a plurality of touchscreens to facilitate receipt and storage of the data into the memory. The resident computer program is adapted to store and manipulate the data based upon user inputs received through the graphical user interface, and the graphical user interface presents a plurality of touchscreens for creating and storing notes specific to the point-of-origin. The notes may be overlaid onto an aerial photograph (or other image) of the selected field.

In yet another form, the present invention comprises a system for electronically recording and processing agricultural and other farming-related data for a selected farm. In this form, the system comprises a mobile device with a touchscreen display for recording data, wherein the mobile device is adapted to be carried by an operator conducting farming-related activities; a service network including a special data handler adapted to perform various back-office functions including addressing operator-originated inquiries and preparing operator-requested reports based upon the agricultural and other farming-related data; and a data link for connecting the mobile device with the service network to facilitate the selective exchange of data between the mobile device and the service network.

In another form, the instant invention comprises a method for electronically storing and manipulating field-specific farming information using a handheld computer having a graphical user interface presented on a touchscreen display. In this form of the invention, the method comprises the steps of the graphical user interface serially generating on the touchscreen display, in response to a farmer selectively touching the touchscreen display, the following touchscreens: (a) an opening touchscreen; (b) an activity-selection touchscreen; and (c) an operation-selection touchscreen having as a background an image of a farmer-selected field for which farming information is to be collected. Between the generation of the activity-selection touchscreen and the generation of the operation-selection touchscreen, the graphical user interface may generate at least one of a select-state touchscreen, a select-county touchscreen, a select-farm-group touchscreen, a select-farm touchscreen, and a select-field touchscreen. These latter touchscreens may include a graphical representation of the respective geographical regions, and this graphical representation may comprise an aerial photograph.

In still another form, the present invention comprises a method for electronically storing and manipulating field-specific farming information for a selected field using a handheld computer having a touchscreen display and a resident computer program controlling a graphical user interface presented on the touchscreen display. In this form, the method comprises the following steps: (a) serially presenting to an operator of the handheld, upon the operator selectively touching the touchscreen display, a plurality of touchscreens for selecting operation parameters for a farming operation, wherein at least a subset of the plurality of touchscreens presents data overlaid upon an aerial photograph of the selected field; and (b) enabling exchange of the farming information between the handheld computer and a service network including a special data handler adapted to perform various back-office functions including addressing an operator-originated inquiry and completing an operator-requested project. The operator-originated inquiry may comprise, for example, a request to have a photographed pest identified. The enabling step may further comprise (i) automatically delivering a pest photograph generated by the operator of the handheld to the special data handler for follow-up research, and (ii) conveying a result of the follow-up research back to the operator.

In yet another form, the present invention comprises a method for electronically storing and manipulating field-specific farming information using a handheld computer having a touchscreen display and a resident computer program to control a graphical user interface that generates a plurality of touchscreens on the touchscreen display. In this form, the method comprises the following steps: (a) enabling a farmer to select a first set of operating parameters that are pertinent to carrying out a farming operation on a first field by serially presenting to the farmer, upon the farmer selectively touching the touchscreen display, an initial series of touchscreens, wherein the initial series of touchscreens comprises a tractor selection touchscreen and a farming tool selection touchscreen; and (b) storing the first set of operating parameters. The method also comprises the following steps: (c) displaying the first set of operating parameters on a touchscreen, wherein the first set of operating parameters are overlaid upon an image of the first field; (d) upon the farmer attempting to create a second set of operating parameters pertinent to carrying out the farming operation on a second field, defaulting values for the second set of operating parameters to values of the first set of operating parameters; and (e) displaying the second set of operating parameters on a touchscreen comprising the second set of operating parameters overlaid upon an image of the second field.

The present invention requires that the farmer only have a single handheld device for recording data and a means for conveying that data stored in the handheld device to a remote service network comprising at least one special data handler.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a schematic, network diagram showing a possible configuration for the overall system of the present invention.

FIG. 2 is a screen shot, flow diagram representing the progression through a typical series of screen shots that may be encountered during use of the present invention.

FIG. 2(A) schematically depicts a pocket computer displaying a sample of an opening screen according to the present invention.

FIG. 2(B) schematically depicts a pocket computer displaying a sample of an activity screen according to the present invention.

FIG. 2(C) schematically depicts a pocket computer displaying a sample of a “select state” screen according to the present invention.

FIG. 2(D) schematically depicts a pocket computer displaying a sample of a “select county” screen according to the present invention.

FIG. 2(E) schematically depicts a pocket computer displaying a sample of a “select farm group” screen according to the present invention.

FIG. 2(F) schematically depicts a pocket computer displaying a sample of a “select farm” screen according to the present invention.

FIG. 2(G) schematically depicts a pocket computer displaying a sample of a “select field” screen according to the present invention.

FIG. 2(H) schematically depicts a pocket computer displaying a sample of a “select operation” screen according to the present invention.

FIG. 3 is a screen shot, flow diagram graphically depicting a sample progression of screen shots for recording a tillage operation on two fields using the same equipment.

FIG. 3(A) schematically depicts a pocket computer displaying a sample of a “tillage” screen shot according to the present invention.

FIG. 3(B) schematically depicts a pocket computer displaying a sample of a tractor-selection screen shot according to the present invention.

FIG. 3(C) is similar to FIG. 3(A), but depicts updated information.

FIG. 3(D) schematically depicts a pocket computer displaying a sample of a tool-selection screen shot according to the present invention.

FIG. 3(E) is similar to FIG. 3(C), but depicts updated information.

FIG. 3(F) is similar to FIG. 3(D), but it depicts a depth-selection screen shot according to the present invention.

FIG. 3(G) is similar to FIG. 3(E), but depicts updated information.

FIG. 3(H) schematically depicts a pocket computer displaying a sample date-selection screen shot according to the present invention.

FIG. 3(I) is similar to FIG. 3(G), but depicts updated information.

FIG. 3(J) schematically depicts a pocket computer displaying a sample time-selection screen shot according to the present invention.

FIG. 3(K) is similar to FIG. 3(I), but depicts updated information.

FIG. 3(L) schematically depicts a pocket computer displaying a sample notes-viewer screen according to the present invention.

FIG. 3(M) is similar to FIG. 3(L), but it depicts an initial add-note field screen shot according to the present invention.

FIG. 3(N) is similar to FIG. 3(M), but it depicts a completed add-note screen shot according to the present invention.

FIG. 3(O) is similar to FIG. 3(L), but it depicts the notes-viewer screen with updated note information.

FIG. 3(P) is similar to FIG. 2(H), but depicts altered date and time values.

FIG. 3(Q) is similar to FIG. 2(G), but depicts altered date and time values.

FIG. 3(R) is similar to FIG. 3(P), but displays a different field in the background of the screen shot.

FIG. 3(S) is the same as FIG. 3(K), but displays a different field in the background of the screen shot.

FIG. 4 is an abbreviated, screen shot, flow diagram for a planting operation.

FIG. 4(A) is similar to FIG. 3(K), but depicts a sample screen for setting planting options.

FIG. 5 is an abbreviated, screen shot, flow diagram for a harvesting operation.

FIG. 5(A) is similar to FIG. 4(A), but depicts a sample screen for setting harvest options.

FIG. 5(B) depicts a sample screen for recording ticket (e.g., harvest grain ticket) information.

FIG. 6 is an abbreviated, screen shot, flow diagram for a spraying operation.

FIG. 6(A) is similar to FIG. 4(A), but depicts a first sample screen for setting options for a spraying operation.

FIG. 6(B) is similar to FIG. 6(A), but depicts a second sample screen for setting options for the spraying operation.

FIG. 7 is an abbreviated, screen shot, flow diagram for a fertilizing operation.

FIG. 7(A) is similar to FIG. 4(A), but depicts a sample screen for setting options for a fertilizing operation.

FIG. 8 is a diagram that graphically presents how the information screens according to an embodiment of the present invention may be presented.

FIG. 8(A) depicts a first sample information screen.

FIG. 8(B) is similar to FIG. 8(A), but depicts a second sample information screen with emergency numbers.

FIG. 9 is a diagram that graphically presents how the shopping screens according to an embodiment of the present invention may be presented.

FIG. 9(A) is similar to FIG. 8(A), but depicts an initial shopping screen.

FIG. 9(B) is similar to FIG. 9(A), but depicts a sample price-items screen.

FIG. 9(C) is similar to FIG. 9(B), but depicts a sample price-seed screen.

FIG. 10 is a diagram that schematically represents how the pest-identification screens according to one embodiment of the present invention may be presented.

FIG. 10(A) depicts an alternative handheld unit and a sample pest-identification screen.

FIGS. 11(A) and 11(B) depict a pocket computer displaying possible screen shots for taking photographs and for reviewing previously-taken photographs.

### DETAILED DESCRIPTION OF THE INVENTION

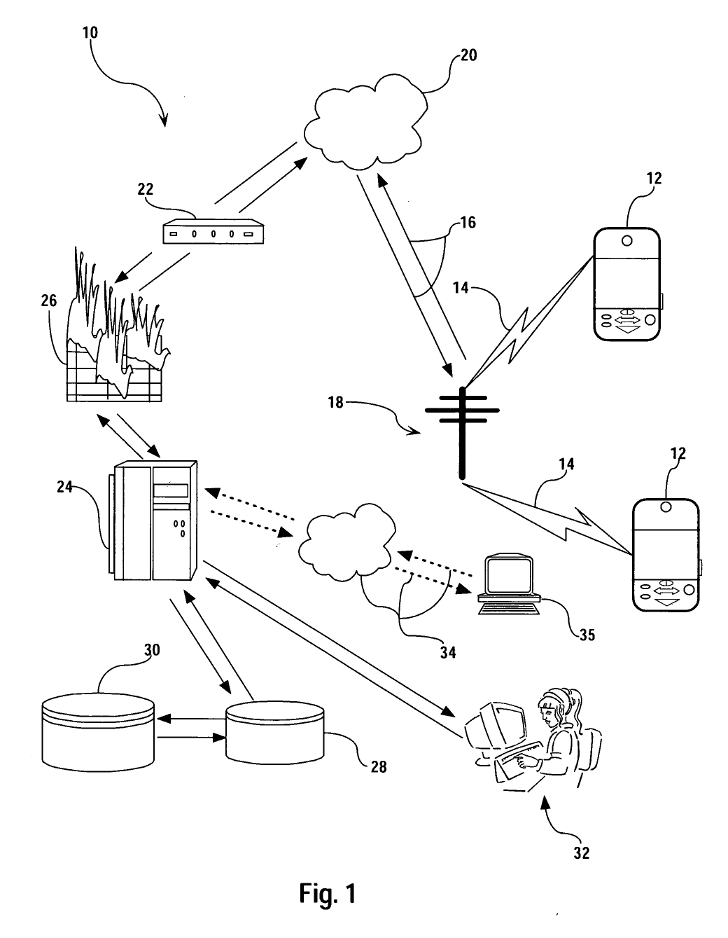

The present invention comprises a system and method for recording, tracking, and processing agricultural and other data, including task-specific and location-specific data. FIG. 1 is a schematic, network diagram showing a possible configuration for the overall system 10 of the present invention according to one embodiment. In this embodiment of the invention, the overall system 10 comprises a number of different hardware and software devices, including one or more handheld units 12 (e.g., pocket computers). These handheld units 12 may be carried by, for example, land owners or farmers, or their employees, and the handheld units 12 may function primarily for data recordation, leaving data processing functions for other system components. As used herein, the term “farmer” includes any person operating a handheld unit 12.

As shown in FIG. 1, these handheld units 12 are wirelessly connected (see item 14 in FIG. 1) to some type of landline 16. In particular, the handheld units 12 are able to wirelessly transmit and receive information via, for example, a hotspot 18 (i.e., a wireless access point) using known data transfer protocols. No Internet access is required for this embodiment. The hotspot may be set up, for example, near the farmer's house or barns to facilitate automatic data back-up and transfer whenever the farmer is in range without user interaction, and the farmer does not require a local personal computer or a desktop computer to facilitate the data back-up and transfer. Assuming the farmer passes by the hotspot 18 at least once a day, there is never more than twenty-four hours between wireless transmissions. This allows for nearly real-time reporting.

Once the data from the handheld units 12 reaches this wireless data hand-off point 18, the data may be moved electronically over the landline 16 (for example, standard phone lines) through a public switched telephone network 20 (PSTN) and a modem 22 to a remote server 24. Prior to reaching the remote server 24, the data may pass through a firewall 26 in order to protect the integrity of the information that reaches the server 24 and to avoid data corruption or loss, whether the result of nefarious or other acts. The server 24 may be configured for storage, backup, processing, and automatic response functions, for example. The server would be able to process data and exchange information with a variety of different databases, including, for example, individual farmer databases 28 and a main database 30. As discussed further below, the system may also include one or more “special data handlers” 32.

In another embodiment of the present invention, the system may comprise a Web interface 34 (i.e., an interface to the World Wide Web or some other global computer network), schematically represented by a cloud and some dotted lines in FIG. 1. In this alternative embodiment, the Web interface 34 may be used by the farmer (via a personal computer 35, for example) to establish configuration settings (e.g., the screens that are viewable and/or alterable by a particular user of a specific handheld unit 12) for one or more of the handheld units 12 being used in that farming operations. This aspect of the present invention is discussed further below.

The “special data handlers” 32 may comprise computer hardware and/or computer software standing alone (for purely automated functions), personnel answering telephone calls or emails (for example, to address customer service and other issues that require or lend themselves to direct contact between a farmer and a “live person”), or a combination of personnel and computer equipment that takes care of various back-office functions (e.g., custom report generation, research in response to farmer inquiries, uploading information for configuring and customizing individual handheld units 12, vendor management, etc.).

For example, farmers are asked to provide complex reports to meet EPA compliance requirements. Since farmers may be asked to provide such reports relatively infrequently, being able to centralize the generation of these reports into a shared-service model whereby specially-trained personnel, who can quickly and efficiently prepare reports in a cost-effective manner (because they repeatedly prepare such reports for a number of different farmers), are available, further simplifies the non-directly-farming-related efforts of farmers. These personnel may have, for example, special form-generation software available to them, and they may receive ongoing training concerning requirements for completing reports and other documents required or requested by farmers. Farmers are better able to focus on the things they know best and the things that generate revenue for them, and they can leave the other aspects of their businesses (e.g., the generation of specialized reports for government compliance purposes and storage of historical information) to individuals with special expertise and special equipment. These special data handler aspects may be implemented in a 24×7 operation.

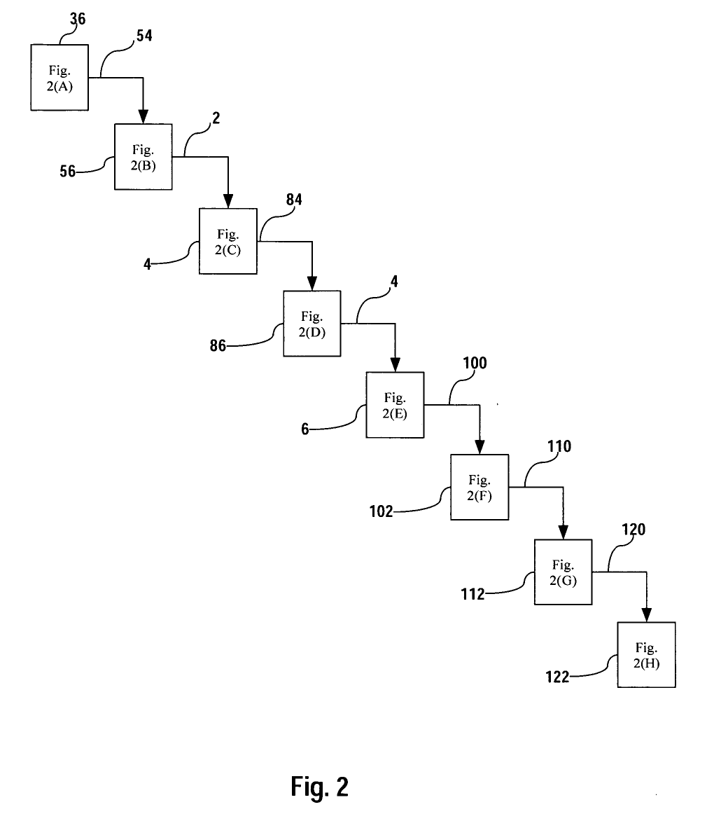

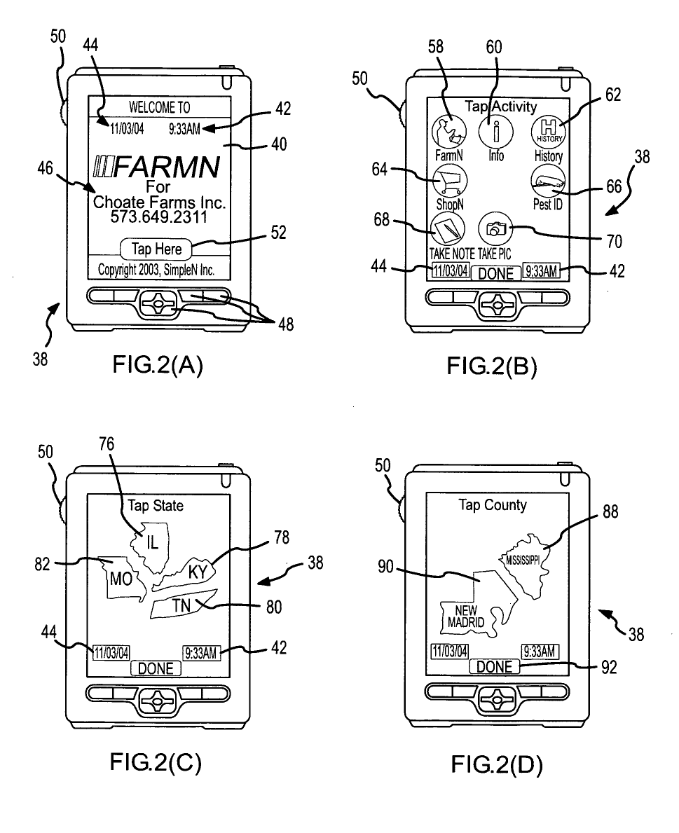

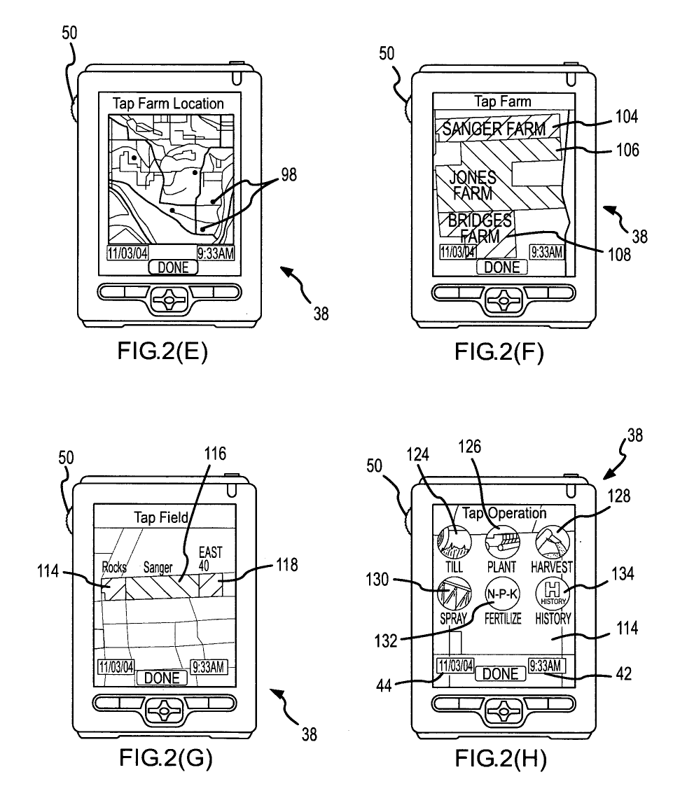

FIG. 2 is a screen shot, flow diagram representing the progression through a typical series of screen shots that may be encountered during use of the present invention. In particular, this figure schematically represents a sample progression through several screens from an opening screen down through an initial field selection screen, and then to a “Select Operation” screen according to one embodiment of the present invention. Operation box 36 (FIG. 2) schematically represents program logic that displays the screen shot 40 depicted in FIG. 2(A).

As shown in FIG. 2(A), a pocket computer 38 (i.e., one type of handheld unit 12 shown in FIG. 1) according to one embodiment of the present invention may display an opening screen 40 of a GUI, wherein the opening screen may include the current time 42 and the current date 44. Clearly, the format in which the time 42 and the date 44 are presented may be user configurable (e.g., rather than what is depicted in FIG. 2(A), the pocket computer 38 may present time in a 24-hour time format). In the description that follows, it is assumed that the current date is 3 Nov. 2004 as shown in FIG. 2(A). Further, in the embodiment depicted in FIG. 2(A), the opening screen 40 also displays information 46 identifying the owner of the pocket computer 38 or the farm for which the unit is configured to record and track agricultural information. The pocket computer 38 may include a plurality of physical operation or control buttons 48. In addition, an on/off button 50 may be present. Although the pocket computer 38 may include such operation and control buttons 48, no keyboard or typing is required to effectively use the handheld unit when configured according to the present invention.

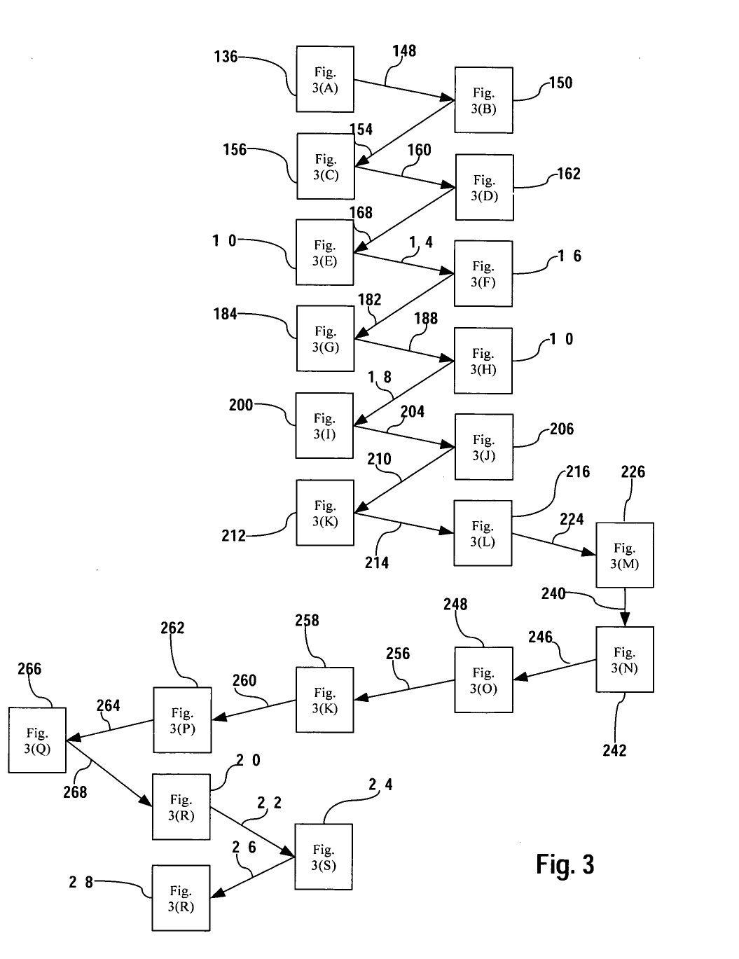

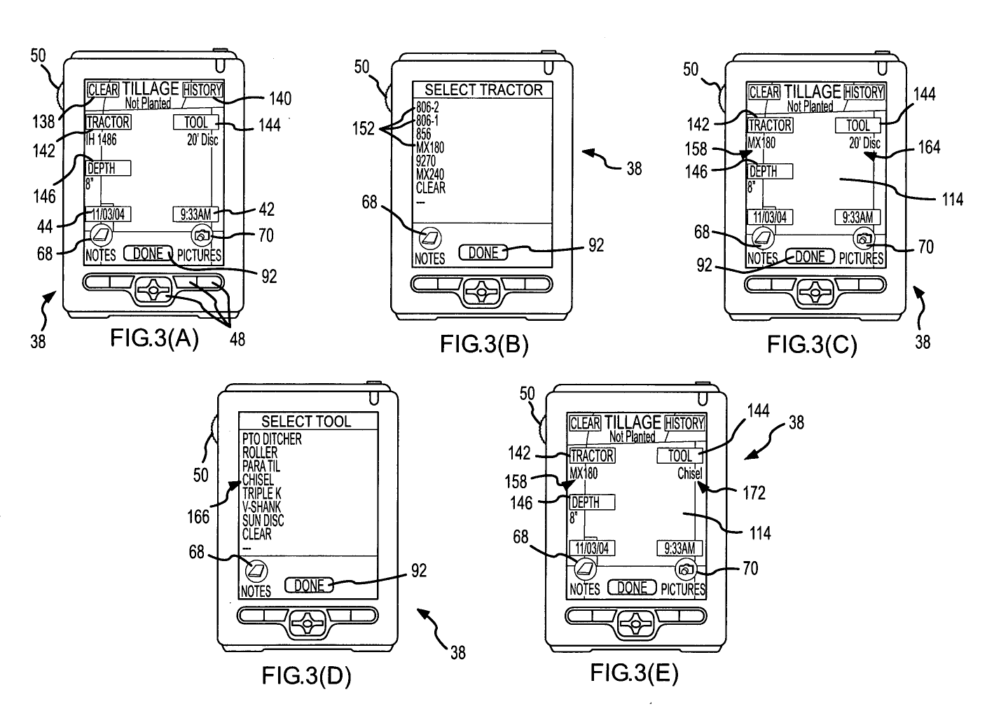

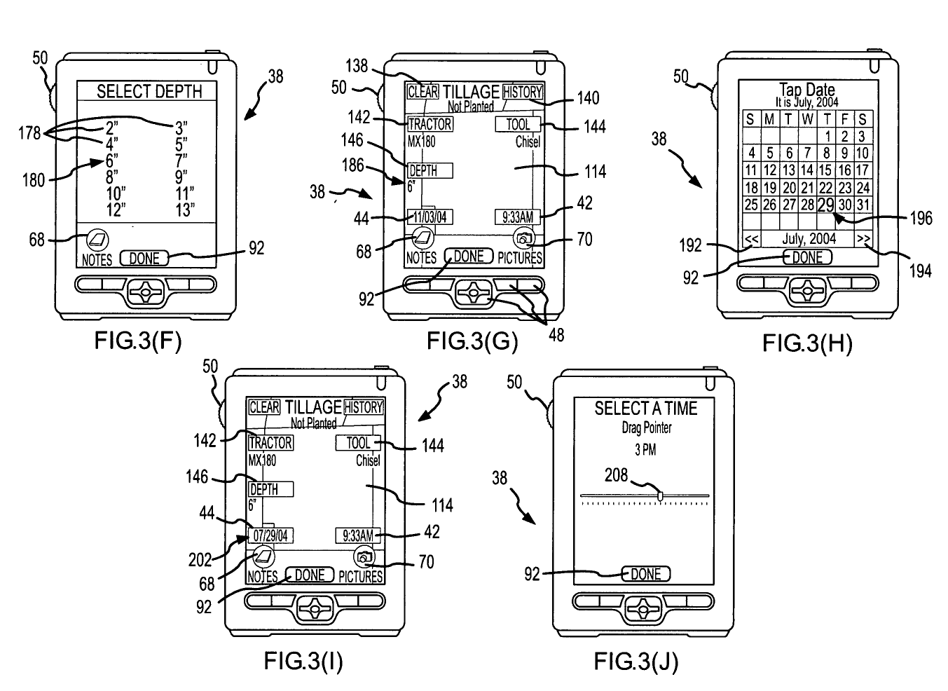

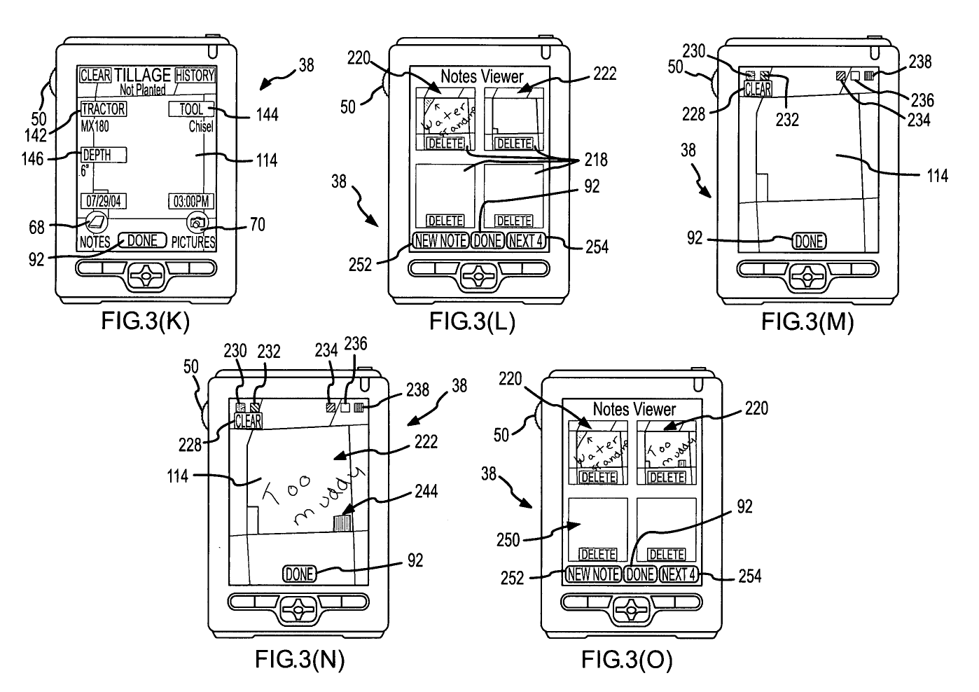

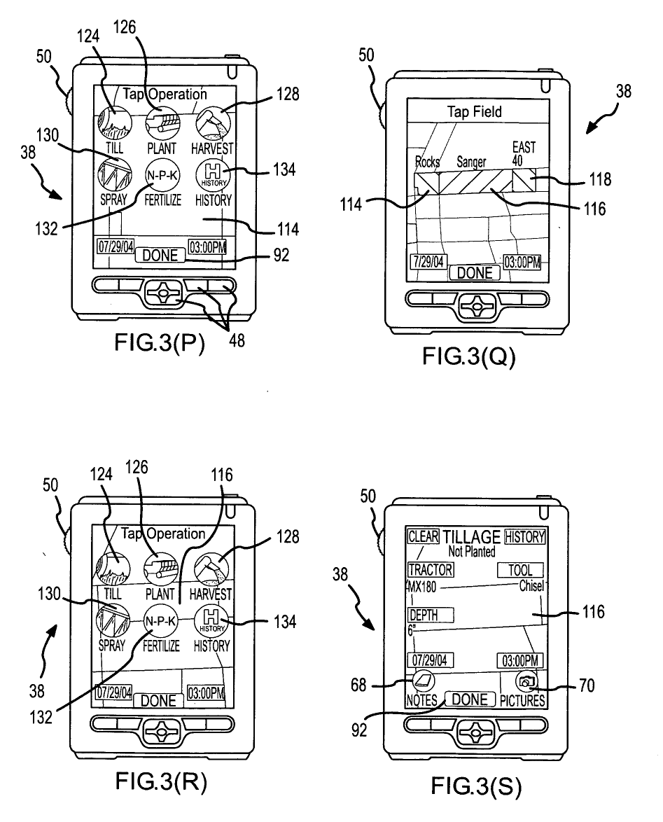

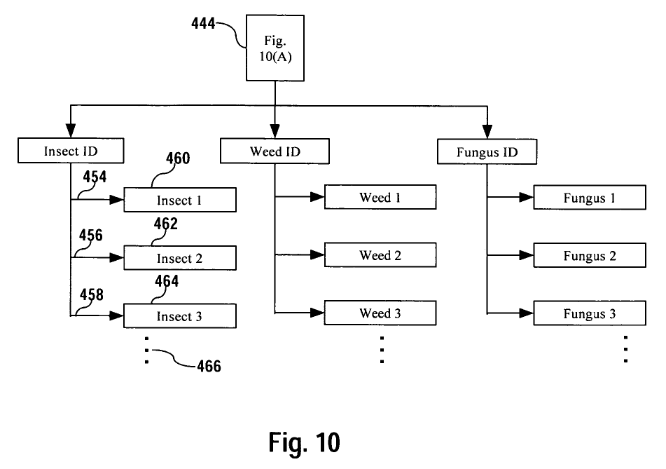

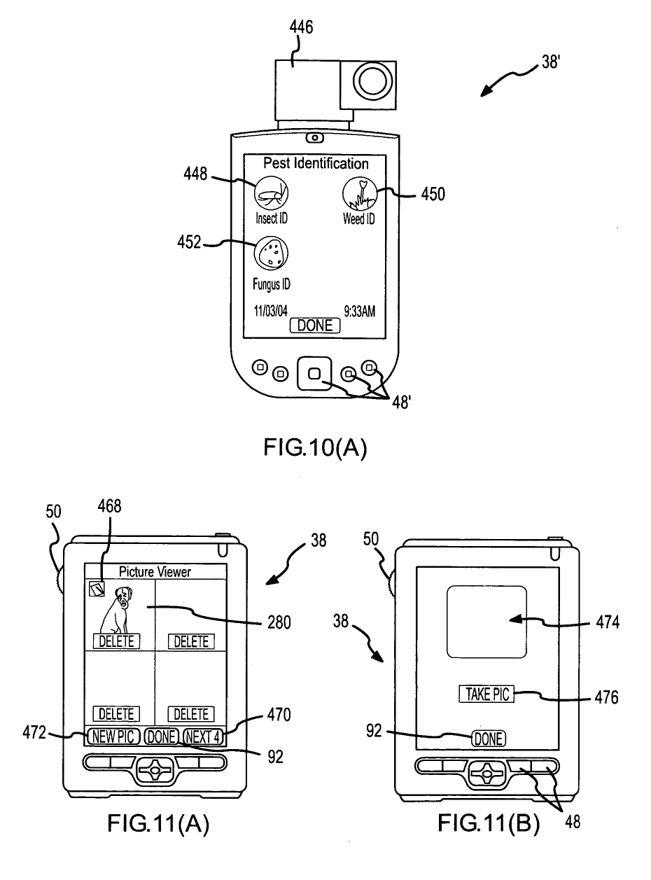

The pocket computer 38 may include additional features that are known in the art but may not be shown in the figures including, for example, a built-in stylus holder, an integrated or detachable camera (shown attached to the alternative pocket computer 38′ depicted in FIG. 10(A)), and/or an integrated or detachable microphone. Desirably, the pocket computer is fairly abuse tolerant and able to withstand the rigors of the agricultural environment. For example, the pocket computer 38 should be drop resistant, weather resistant, and chemical resistant. Upon initial startup, such a “welcome screen” 40 may appear for ready confirmation that an appropriate pocket computer has been selected. For example, a farming operation may assign particular pocket computers to particular farming operations—an appropriate opening screen would provide ready confirmation that the correct pocket computer has been selected for the farming operation about to be performed. Desirably, the pocket computer 38 requires no boot-up time so that data can be entered instantly. Additionally, once the unit has been used at least once, the system restarts wherever it was when it was last turned on. For example, if the pocket computer 38 powers down, intentionally or unintentionally, on any one of the screens depicted in FIGS. 2(A), 2(B), 2(C), 2(D), 2(E), 2(F), 2(G), 2(H), 3(A), 3(B), 3(C), 3(D), 3(E), 3(F), 3(G)), 3(H), 3(I), 3(J), 3(K), 3(L), 3(M), 3(N), 3(O), 3(P), 3(Q), 3(R), 3(S), 4(A), 5(A), 5(B), 6(A), 6(B), 7(A), 8(A), 8(B), 9(A), 9(B), 9(C), 10(A), 11(A), and 11(B), the pocket computer returns to the screen that it was on upon power down once the unit is turned back on. This feature makes it possible for a farmer to conserve power on the unit (e.g., by intentionally powering down) without losing his place. The farmer is not required to restart the computer program from one or more operation system screens.

After initial startup of the pocket computer 38, the farmer commences use of the device by touching the active region of the touchscreen, i.e., by touching in the vicinity of the “Tap Here” button 52 on the opening screen 40. As used herein, a “touchscreen” is an image generated by a GUI on a “touchscreen display,” which is the hardware on which a touchscreen generated by the GUI is actually presented. That “tap” on the opening screen is represented by connector line 54 in FIG. 2 and, as shown in FIG. 2, transfers program control to operation box 56, resulting in the display of, for example, the screen shot depicted in FIG. 2(B). FIG. 2(B) schematically depicts a pocket computer 38 displaying a sample of an activity screen according to the present invention.

Referring to FIG. 2(B), after leaving the opening screen 40 of FIG. 2(A), the farmer is encouraged to select or tap an activity. In FIG. 2(B), a variety of sample activities are shown, including an icon 58 for recording farming information; an icon 60 for reviewing information stored by the user; an icon 62 for reviewing history information; an icon 64 for shopping, pricing items, and making purchases; and an icon 66 for identifying pests. There are two additional activity icons 68, 70 shown in FIG. 2(B). In particular, the icon 68 is present for taking general notes and the icon 70 is present for taking pictures when the pocket computer 38 is configured with a camera (the pocket computer 38 is assumed to have a built-in camera). Clearly, more or fewer activity icons may be available depending upon user preference (discussed further below).

Since the pocket computer 38 according to the present invention is configured for use by people having any educational background, the icons 58-70 depicted in FIG. 2(B) and the icons depicted in all of the other screens preferably clearly represent the corresponding activity or task. This may be particularly helpful if the user fails to understand the written information presented on the screen (e.g., FarmN, Info, History, ShopN, Pest ID, Take Note, Take Pic, etc.). The use of a limited number of informative icons 58-70 makes the present invention readily useable by anyone, regardless of potential language barriers, cross-cultural issues, or computer literacy. In order to further simplify some of the screens discussed herein, it may be desirable to further reduce the amount of displayed information. Thus, for example, the date 44 and time 42 need not appear on each screen and need not appear in boxes.

We next assume that the farmer taps on the farming icon 58 depicted in FIG. 2(B) (i.e., the farmer taps either the picture of the farmer sitting on a tractor or taps the word “FarmN”). This tap is schematically represented by connector line 72 in FIG. 2 and transfers control to operation box 74 in FIG. 2. At this point, the system displays, for example, a screen like that shown in FIG. 2(C). FIG. 2(C) is a “state selection” screen—that is, it shows graphical representations of any state or states in which the farmer conducts farming or other agricultural operations. In particular, if the farmer farms in more than one state, a state selection screen similar to the screen depicted in FIG. 2(C) may be presented. In the sample screen shot of FIG. 2(C), the farmer conducts agricultural operations in the states of Illinois 76, Kentucky 78, Tennessee 80, and Missouri 82. In order to reduce the number of entry points and to remove the need for extensive drop-down lists, the farmer or other user need merely tap on a state containing the farms in which agricultural data is to be recorded. If the user knows either the two letter postal code for the state or the shape of the state, it becomes a simple matter for the user to select the correct state.

We next assume that the farmer taps on the icon 82 for the state of Missouri when presented with the screen shot depicted in FIG. 2(C). This tap on icon 82 is represented by connector line 84 in FIG. 2, which switches program control to operation box 86, resulting in the display of, for example, the screen shot depicted in FIG. 2(D). FIG. 2(D) schematically depicts a pocket computer 38 displaying a sample “select county” screen according to the present invention. As shown in FIG. 2(D), this particular farmer conducts agricultural operations in two counties within the state of Missouri. In particular, a farmer conducts agricultural operations in Mississippi County and in New Madrid County. Again, the user must either recognize the name of the county in which the farm resides where agricultural information is to be recorded or the shape of that county. To make a county selection, the user need only tap on the appropriate county icon 88, 90 or county name. It should be noted that, in general, if the user taps on the virtual button 92, on which the word “DONE” appears, the software returns the user to the previous screen, in this case, the screen depicted in FIG. 2(C). This is true for each of the screens depicted in the various figures.

The user's tap on the Mississippi county icon 88 depicted in FIG. 2(D) is represented by the connector line 94 in FIG. 2. Thus, program control is transferred to operation box 96 in FIG. 2, resulting in the display of a screen like that depicted in FIG. 2(E). FIG. 2(E) schematically depicts a pocket computer 38 displaying a sample of a “select farm group” screen according to the present invention. In particular, the screen shot depicted in FIG. 2(E) is an enlarged view of at least a portion of the selected county (in this case Mississippi County), showing each of the locations (represented by dots 98) where the farmer conducts agricultural operations in the selected county. At this point, the user of the pocket computer 38 would tap on one of the dots 98, which represent locations of “farm groups.” In the screen shot depicted in FIG. 2(E), as well as in the screen shots depicted in FIGS. 2(C) and 2(D), the background may be an aerial photograph or other image.

At this point, the user taps on an appropriate farm location dot 98 in FIG. 2(E). This tapping step is represented by connector line 100 in FIG. 2. As shown in FIG. 2, program control then transfers to operation box 102, resulting in the display of, for example, the screen shot shown in FIG. 2(F). FIG. 2(F) schematically depicts a pocket computer 38 displaying a sample of a “select farm” screen according to the present invention. This screen preferably depicts in the background an aerial photograph of the farms 104, 106, 108 comprising the selected farm group. As depicted in FIG. 2(F), the user selected a farm group comprising the following three farms: Sanger Farm 104, Jones Farm 106, and Bridges Farm 108. In order to facilitate easy identification of the boundaries of the three farms, a cross-hatch patterns like that shown in FIG. 2(F) may be overlaid onto the farms. Alternatively, if the pocket computer 38 has a color screen, each separate farm may be outlined in a different color to aid the user in selecting a particular farm from a displayed farm group. Thus, the aerial photograph of the farms comprising the selected farm group may be enhanced with, for example, cross-hatching, colors, or shading to identify individual farms. The farm names shown in FIG. 2(F) need not be present if the user is able to tell from the aerial photograph alone which farm is which.

In the depicted example, the user is assumed to have selected the Sanger Farm 104 by tapping on an appropriate portion of the screen depicted in FIG. 2(F). This tapping step is represented schematically by connector line 110 in FIG. 2, which transfer control to operation box 112. In operation box 112, a screen similar to that shown in FIG. 2(G) is displayed on the pocket computer 38. FIG. 2(G) schematically depicts a pocket computer 38 displaying a sample of a “select field” screen according to the present invention. In particular, the handheld now displays a further enlarged view of the three fields comprising the Sanger Farm, namely Rocks 114, Sanger 116, and East 40 118. Again, the background of this screen may be an aerial photograph. Also, the separate fields again may be evidenced by colored borders, special shading, or cross-hatching (like that shown in FIG. 2(G)). As previously mentioned, the actual names of the fields need not be shown on the screen if the user can identify the fields from the aerial photograph (or other background image) alone. Although inclusion of the names of the fields may be beneficial, when the farmer clearly recognizes his fields from the background image, the farmer acts as his own “human positioning system” and the field names can become unnecessary clutter on the display. No Global Positioning System (GPS) is required—the farmer or other field worker knows where he is since he has, most likely, worked that field dozens if not hundreds of times. At this point, the user is required to select a field in which he intends to carry out an agricultural operation.

We next assume that the farmer taps on the Rocks field 114 when presented with the screen shot depicted in FIG. 2(G), i.e., the most leftward of the three fields depicted in that figure. This tap on the Rocks field 114 displayed in is represented by connector line 120 in FIG. 2 and transfers program control to operation box 122 in that same figure. In operation box 122, the system displays, for example, the screen shot depicted schematically in FIG. 2(H), wherein the pocket computer 38 displays a sample of a “select operation” screen according to the present invention. In FIG. 2(H), an aerial photograph (or other image) of the selected field (i.e., the Rocks field 114) now appears in the background. By analogy to a typical PC, the “wallpaper” is now an aerial photograph of the Rocks field 114 on which the farmer intends to conduct agricultural operations or for which the farmer intends to record information about a previously-conducted agricultural operation.

The screen shots depicted in FIG. 2(A) through FIG. 2(H) graphically demonstrate that, in a matter of seven simple taps on the touchscreen display, a farmer having extensive farming operations in a number of states has now progressed from the opening screen 40 through selection of a single field 114 from a potentially large number of fields comprising a large number of farms, in a large number of locations, in a large number of counties, in several states. The farmer was not required to scroll through a single (potentially long) list of names (e.g., field names) and merely had to recognize a series of icons and aerial photographs in order to make appropriate selections. Clearly, if the farmer only farmed in a single state, the screen shot depicted in FIG. 2(C) would be unnecessary. In other words, if the farmer performed agricultural operations in only a single state, upon selection of, for example, the “FarmN” icon 58 in FIG. 2(B), the farmer would be immediately transferred to the screen depicted in FIG. 2(D). The screen shots depicted in FIGS. 2(D), 2(E), 2(F), and 2(G) may be similarly unnecessary depending upon the location and extent of the particular farmer's operations. For example, if the farmer only conducted agricultural operations in a single field, upon tapping the “FarmN” icon 58 in FIG. 2(B), the farmer may be directly transferred to the screen shot depicted in FIG. 2(H). The present system's use of simple graphical representations, simple icons, small photographs, and aerial photographs makes the system highly intuitive and easy to understand. Since the interface is easily grasped by people of a wide variety of educational and cultural backgrounds, no formal training is required to begin using this system effectively.

From the screen depicted in FIG. 2(H), the farmer can select the operation to be performed on the field 114 depicted in the screen background (i.e., as the pocket computer's “wallpaper”). Thus, FIGS. 2, 2(A), 2(B), 2(C), 2(D), 2(E), 2(F), 2(G), and 2(H) depict a sample series of screen shots via which a user would transition from an opening screen 40 through the final selection of a field 114 for which the user desires to record agricultural or other information. This series of screen shots represents part of a location-centric or location-specific (i.e., point-of-origin) process for tracking data. With the selected field displayed in the background of the operation-selection screen depicted in FIG. 2(H), the user is left with no doubt the field (in this case the Rocks field 114) for which the operation information that is about to be selected will be recorded.

The screen shot of FIG. 2(H) depicts a sample of agricultural operations that may be selected by the farmer. In this depicted embodiment, the farmer may select, for example, a tillage icon 124, a planting icon 126, a harvesting icon 128, a spraying icon 130, or a fertilizing icon 132. The farmer may also review operation history for the depicted field by tapping on the history icon 134. Of course, more or fewer operations may be available for the farmer to select from depending upon the agricultural operations of interest to the particular farmer and the configuration settings for the particular pocket computer. Upon reviewing the screen shot depicted in FIG. 2(H), the farmer also knows that the operation will be recorded for the indicated time 42 on the indicated date 44. A procedure for changing the date and time for the operation that is being recorded is discussed further below.

Referring next to FIGS. 3 and 3(A)-3(F), sample screen shots for recording information about a particular agricultural operation on a selected field are described next. FIG. 3 is a screen shot, flow diagram (similar to FIG. 2) that graphically depicts a sample progression of screen shots for recording a tillage operation on two fields using the same equipment. In particular, FIG. 3 schematically depicts the process for recording tillage information, including the process of setting up the pocket computer 38 to record information for a first field and subsequent set-up steps for recording information on a second field. Thus, FIG. 3 schematically depicts steps for recording a tillage operation on two fields. In general, a rightwardly pointing arrow represents “forward progression” through the series of screens, and a leftwardly pointing arrow represents “backward progression” through the series of screens (i.e., returning to a previous screen rather than advancing to a new screen). Also, operation boxes that are aligned vertically in FIG. 3 represent screen shots at roughly the same “level” within the series of screens. For example, operation boxes 136, 156, 170, 184, 200, 212, 258, and 274, which are arranged in a single vertical column in FIG. 3, each depicts the tillage operation screen in a different state. Each of the eight screen shots presented to the user upon reaching one of these eight operation boxes, however, may have slightly different information depending upon user-selected options as the farmer progresses through the screens during the use of the pocket computer 38.

At operation box 136 (FIG. 3), it is assumed that the tillage icon 104 depicted in FIG. 2(H) has been selected or “tapped” resulting in the display of the screen shot depicted in FIG. 3(A), which is the “tillage operation” screen. Since the user, upon viewing the screen shot of FIG. 3(A), is able to actually record a “tillage operation” by selecting the “DONE” button 92, the unit may be configured such that this is the first screen that displays the time 42 and date 44 if it is desirable to place minimal information on the screens (i.e., none of the screen shots depicted in FIGS. 2(A)-2(H) may display the date and time if minimizing screen “clutter” is desirable). The tillage screen includes a variety of user-selectable buttons including, for example, a “clear” button 138, a “history” button 140, a “tractor” button 142, a “tool” button 144, and a “depth” button 146. At this point, as shown in FIG. 3(A), the pocket computer 38 may also display a “Notes” icon 68 and a “Pictures” icon 70. The present invention is not limited by this exact selection or arrangement of user-selectable buttons 42, 44, 68, 70, 138-146. Rather, the screen shot of FIG. 3(A) displays a representative sample of possible virtual buttons and icons.

The first time that the farmer uses the pocket computer 38, values for “tractor,” “tool,” and “depth” may not be presented upon reaching the “tillage operation” screen of FIG. 3(A). In one preferred embodiment, however, upon the farmer's return to this “tillage operation” screen to record a subsequent tillage operation after an initial use of the device 38 to record a first tillage operation, the previously-selected values for these three items may remain selected (i.e., the system defaults to the last-selected values for the particular operation, but the farmer may change these “default values” as desired). In particular, as shown in FIG. 3(A), the selected tractor is an “IH 1486,” the selected tool is a “20″ Disc,” and the selected depth is “8″.” The next time the farmer reaches the tillage screen upon subsequent use of the pocket computer 38, these same values for the tractor, tool, and depth remain selected, saving the farmer time if the farmer intends to use the same equipment for his next tillage operation. A simple tap on the “clear” button 138 would clear all of the depicted values for the “tractor,” the “tool,” and the “depth.”

If the farmer were to inadvertently or accidentally reach the screen shot depicted in FIG. 3(A) by tapping on “TILL” in FIG. 2(H), for example, the farmer could exit from the screen shot of FIG. 3(A) without recording a tillage operation. In particular, after the farmer taps the “DONE” button 92 on the screen depicted in FIG. 3(A), he is given an opportunity to confirm that a tillage operation is to be recorded. In response to that “confirmation request,” which appears upon selection of the “DONE” button 92, the farmer would tap on the option to not save the tillage operation and would then be returned to the screen shot of FIG. 2(H) without a change in the stored data. A similar “confirmation request” is presented to the farmer any time tapping on the touchscreen may result in storing new information or changing previously-stored information. If, on the other hand, the farmer would like to see how the tillage equipment was configured in the past when a tillage operation was previously performed on the field 114 depicted in the background, the farmer would tap on the “history” button 140.

Returning to FIG. 3 and FIG. 3(A), the depicted example assumes that the farmer desires to select a different tractor for the present tillage operation. The farmer initializes selection of a new tractor by tapping on the “tractor” button 142 depicted in FIG. 3(A), an operation which is represented by a connector line 148 in FIG. 3. This transfers program control to operation box 150 in FIG. 3, resulting in the display of, for example, the screen shot depicted in FIG. 3(B). FIG. 3(B) schematically depicts the pocket computer 38 displaying a sample of a tractor-selection screen shot according to an embodiment of the present invention. This screen lists each of the tractors 152 that this particular farmer uses for this particular operation (i.e., tillage). Although the farmer may own tractors in addition to those shown on the screen shot depicted in FIG. 3(B), if the farmer has not designated or allocated those additional tractors for use in a tillage operation, they will not appear on the “select tractor” list depicted in FIG. 3(B).

As mentioned in connection with the description of FIG. 1, the back-office special data handler 32 may preconfigure the farmer's pocket computer 38 to list the specific tractors that that farmer owns for the different operations. In other words, if the farmer wants to have the pocket computer 38 preconfigured for his particular equipment, he can provide information to the special data handler 32 concerning what tractors and other equipment he uses for a variety of different operations. The pocket computer 38 could then be initially delivered to the farmer in this preconfigured state, wherein the farmer's specific equipment has been “pre-loaded” into the unit. Optionally, the farmer could, upon reaching the screen shot of FIG. 3(B), tap on the notes icon 68 and “write in” (e.g., using a stylus) the names of the different tractors that the farmer wants to use for future tillage operations. The use of the “notes” feature of the present invention is described further below in connection with FIGS. 3(L)-3(O). The farmer also could have his pocket computer 38 preconfigured by calling or emailing the special data handler 32 so that the special data handler could subsequently upload appropriate information for the particular farmer to that farmer's particular handheld unit or pocket computer.

The “notes” icon 68 may also be used to request reconfiguration of the pocket computer 38 when the farmer's equipment changes. If the farmer, upon reviewing the tractors 152 listed in FIG. 3(B) realizes that he has sold his “9270” (or no longer uses it for tillage), for example, the farmer may want to remove that tractor from the list of tractors 152. One way that he could do that is by tapping on the “notes” icon 68 and stating that he no longer owns the 9270. The next time data is uploaded from the handheld unit 12 (e.g., pocket computer 38) to the server 24 (FIG. 1), the special data handler 32 would receive notification that the 9270 tractor needs to be removed from this farmer's list of tractors available for tillage operations. The next time that the farmer reached the “select tractor” for tillage operation screen depicted in FIG. 3(B), the 9270 would no longer appear on the list of tractors 152. Also, as discussed further below, the farmer may use the optional Web interface 34 (see FIG. 1) to change, customize, and reconfigure the appearance and operation of each pocket computer 38.

FIG. 3(A) shows that the “IH 1486” tractor was previously selected for a prior tillage operation. However, in the “select tractor” list 152 depicted in FIG. 3(B), the “IH 1486” is no longer present. Thus, the farmer, in this example, must have previously tapped on the “notes” icon 68 in FIG. 3(B) (or the farmer must have otherwise contacted the special data handler 32, or the farmer must have used the optional Web interface 34) and requested removal of the “IH 1486” tractor from the list of tractors 152 available for a tillage operation (or removal of the “IH 1486” tractor from all “select tractor” screens). The farmer may still own the “IH 1486,” but he may have decided that he no longer wants to use this particular tractor for tillage operations and thus requested its removal from the “select tractor” list 152 depicted in, for example, FIG. 3(B). Through use of the “notes” icon 68 or other contact with the special data handler 32, or via the Web interface 34, all display screens from which the farmer is asked to select equipment are fully customizable. This provides an opportunity for data related to, for example, all of the tractors owned by the farmer to be filtered for accuracy through farmer-set parameters. In this manner, the software running on the farmer's pocket computer 38 evolves dynamically as the farmer uses it. Each handheld unit becomes customized to the farmer's particular operation and method of farming.

The notes icon 68 depicted in, for example, FIG. 3(B) may appear differently when at least one note is present for the screen being viewed. For example, if the farmer had previously created a note related to the “select tractor” screen depicted in FIG. 3(B), the “notes” icon 68 may be changed slightly to visually indicate that at least one note is present.

In the example depicted in the figures, it is next assumed that a farmer selected the MX180 tractor when presented with the list of tractors 152 depicted in FIG. 3(B). This tractor selection is represented by connector line 154 in FIG. 3, which transfers program control from operation box 150 to operation box 156 in FIG. 3. At operation box 156, the screen shot depicted in FIG. 3(C) is displayed. The screen shot depicted in FIG. 3(C) is similar to the screen shot depicted in FIG. 3(A). The screen, however, now reflects, at 158, the farmer's selection of his MX180 tractor.

At this point in the sample progression of screens, the farmer elects to select a different tool by tapping on the tool icon 144 displayed in the screen shot of FIG. 3(C). This tapping operation is represented by connector line 160 in FIG. 3 and transfers program control to operation box 162 in FIG. 3. At operation box 162 in FIG. 3, the screen shot depicted in FIG. 3(D) is displayed to the farmer. FIG. 3(D) schematically depicts the pocket computer 38 displaying a sample of a tool-selection screen shot according to the present invention. By comparing the screen shot depicted in FIG. 3(C) to the screen shot depicted in FIG. 3(D), it is apparent that the farmer has again either sold his “20′ Disc” (see item 164 in FIG. 3(C)), or he has reallocated this tool to non-tillage agricultural operations. This is apparent since the “20′ Disc” (see item 164 in FIG. 3(C)), no longer appears on the select tool screen displayed in FIG. 3(D). Since the “20′ disc” tool appears on the screen shot depicted in FIG. 3(C), the farmer previously had this particular tool allocated to tillage operations since it had to have been selected in a prior tillage operation for it to appear in the screen shots of FIGS. 3(A) and 3(C).

Continuing with our sample progression of screens, we now assume that the farmer has selected the “CHISEL” tool when presented with the screen shot depicted in FIG. 3(D). This tapping selection of “CHISEL” on FIG. 3(D) is represented by connector 168 in FIG. 3, whereby program control is transferred to operation box 170 in FIG. 3(D). At this point (i.e., at operation box 170 in FIG. 3), the program logic displays to the farmer the screen shot depicted in FIG. 3(E). The screen shot of FIG. 3(E) is similar to the screen shots depicted in FIGS. 3(A) and 3(C). In the screen shot of FIG. 3(E), however, the selected tractor is the “MX1 80” (see item 158) and the selected tool is the “Chisel” (see item 172).

Once presented with the screen shot depicted in FIG. 3(E), the farmer, in the present sample progression, elects to change the tillage depth by tapping on the “depth” icon or button 146 in FIG. 3(E). This tapping by the farmer is represented by connector line 174 in FIG. 3 and transfers program control to operation box 176 in that figure. At operation box 176 (FIG. 3), the screen shot depicted in FIG. 3(F) is presented to the farmer. FIG. 3(F) is similar to FIG. 3(D), but it depicts a depth-selection screen shot according to one embodiment of the present invention. Similar to what has been described above in connection with FIGS. 3(B) and 3(D), the “depth” options 178 presented to the farmer in FIG. 3(F) are configured according to the farmer's preference. The farmer's preference is, as previously mentioned, initially configurable before the pocket computer 38 is delivered to the farmer; and, as the farmer uses the pocket computer 38, he is able to make on-the-fly changes to the options presented in FIG. 3(F). For example, if the farmer decides that, for future tillage operations, he would like to be presented with or able to select “depths” other than the depths 178 presented in FIG. 3(F), he need only tap on the “NOTES” icon 68 depicted in FIG. 3(F) and request the desired changes to his “depth” options 178. The next time that his pocket computer 38 uploads information to the server 24 (FIG. 1), the back-office special data handler 32 can take the appropriate steps to ensure that, with the next download to the farmer's pocket computer 38, the selectable “depth” options 178 on the screen shot of FIG. 3(F) will be adjusted according to the wishes of the farmer. Alternatively, as previously mentioned and as explained further below, the farmer may also change the configuration of any pocket computer via the optional Web interface 34.

Continuing with our sample progression of screen shots, the figures assume that, when presented with the “depth” selection options 178 depicted in the screen shot of FIG. 3(F), the farmer tapped on the 6″ depth option 180. This tapping of the farmer on the 6″ option 180 in the screen shot depicted in FIG. 3(F) is represented by the connector 182 in FIG. 3 and transfers control to operation box 184 of FIG. 3. In operation box 184 of FIG. 3, the system presents the screen shot of FIG. 3(G) to the farmer. Again, FIG. 3(G) is similar to the screen shots depicted in FIGS. 3(A), 3(C), and 3(E), but contains updated information. In the screen shot depicted in FIG. 3(G), the 6″ depth (see item 186) is now shown as the selected tillage depth. At this point (i.e., when the farmer is presented with the screen shot depicted in FIG. 3(G)), the farmer has selected the tractor, the tool, and the depth for the tillage operation for which he is about to record information. At this point, if the farmer were to tap on the “DONE” button 92 depicted in FIG. 3(G) and then confirm that he wants to save a tillage operation in response to the “confirmation request” that would subsequently appear, a tillage operation would be recorded for the field 114 depicted in the background of FIG. 3(G), using the indicated equipment and the indicated depth. This tillage operation would be recorded as having been performed on the date indicated in block 44 and at the time indicated in block 42.

In the sample screen progression depicted in the figures, however, it is assumed that the farmer wishes to record a tillage operation that occurred in the past using the selections depicted in FIG. 3(G). Thus, FIG. 3(G)-FIG. 3(J) show how the farmer is able to change the date and time that will be associated with a recorded tillage operation. To change the date, the farmer taps on the date box 44 depicted in FIG. 3(G). This tap on the date box 44 is represented by the connector line 188 in FIG. 3 and transfers control to operation box 190 in FIG. 3. The program, at operation box 190 in FIG. 3, displays the screen shot depicted in FIG. 3(H). FIG. 3(H) schematically depicts the pocket computer 38 displaying a sample date-selection screen shot according to the present invention.

When presented with the screen shot depicted in FIG. 3(H), the farmer is able to tap at an appropriate location on the screen to select the date for which he wants to record the tillage operation. The farmer may move backward one month at a time by tapping on the double arrow button 192, or the farmer may move forward one month at a time by tapping on the double arrow button 194. The screen depicted in FIG. 3(H) may include additional navigation and date selection options (e.g., a “today” button may be present to instantaneously transfer the farmer to today's date, or the farmer may be able to move in different temporal increments). The pocket computer 38 may be set up to take the date and time from, for example, the remote server 24 depicted in FIG. 1 during uplink and downlink operations. In our example, the farmer has tapped on the “29” day button 196 in the screen shot of FIG. 3(H). To confirm for the farmer that this day selection has been made, the selected day may change appearance. For example, in the screen shot of FIG. 3(H), the number “29” appears larger than the other numbers representing the days of the month.

Once the farmer has navigated to the correct month and year and has selected the desired day of that particular month, he must tap on the “DONE” button 92. This tapping on the “DONE” button 92 displayed in FIG. 3(H) is represented by connector line 198 in FIG. 3 and transfers program control to operation box 200 in FIG. 3. At this point (i.e., at operation box 200 of FIG. 3), the screen shot depicted in FIG. 3(I) is presented to the farmer. The screen shot depicted in FIG. 3(I) is similar to the screen shots depicted in FIGS. 3(A), 3(C), 3(E), and 3(G), but includes updated information. In particular, in the screen shot of FIG. 3(I), the date just selected by the farmer (i.e., Jul. 29, 2004) now appears on the tillage screen (see item 202 in FIG. 3(I)).

In our sample screen shot progression, it is assumed that the farmer now wishes to change the time for the tillage operation that is about to be recorded. To change the time, the farmer taps on the “time” box 42. Clearly, there may not be an actual “box” around the time. The farmer need merely tap on the time if the farmer desires to change the time associated with a particular operation. Tapping on the “time” box in FIG. 3(I) is represented schematically by the connector line 204 in FIG. 3, whereby control is transferred from operation box 200 to operation box 206 in FIG. 3. In operation box 206, the screen shot depicted in FIG. 3(J) is presented to the farmer.

FIG. 3(J) schematically depicts the pocket computer 38 displaying a sample time-selection screen shot according to one embodiment of the present invention. When presented with the screen shot of FIG. 3(J), the farmer is able to drag the pointer 208 in order to set the desired time. Again, the screen depicted in FIG. 3(J) may include additional features. For example, a “current” time button (not shown) may appear, allowing the farmer to quickly set the time to be associated with the tillage operation to the current time. As previously stated, the “current” time may be network time received from the server 24.

Once the appropriate or desired “time” has been set, the farmer need only tap on the “DONE” button 92 in FIG. 3(J) to continue. Tapping on the “DONE” button 92 in FIG. 3(J) is represented schematically by connector line 210 in FIG. 3, which transfers control to operation box 212 in that figure. In operation box 212 of FIG. 3, the system presents the farmer with the screen shot of FIG. 3(K). The screen shot depicted in 3(K) is the “tillage” page (see also, FIGS. 3(A), 3(C), 3(E), 3(G), and 3(I)). FIG. 3(K), however, depicts updated information. Through appropriate selections on the screen shots depicted in FIGS. 3(H) and 3(J), the farmer can record operations performed in the past, present, or future. When presented with the screen shot depicted in FIG. 3(K), the farmer can then confirm that he has the appropriate tractor, tool, and depth selected, and that he has the correct date and time associated with the tillage operation for which he is about to record data for the field 114 depicted in the background.

In our sample progression of screen shots, it is assumed that, upon reaching the screen shot depicted in FIG. 3(K), the farmer is satisfied with the equipment and date as presented, but the farmer wants to make a couple of notes about things that he experienced in the field while performing this tillage operation. Thus, when presented with the screen shot depicted in FIG. 3(K), the farmer is assumed to have tapped the notes icon 68. This tapping of the notes icon 68 in the screen shot of FIG. 3(K) is represented schematically by connector line 214 in FIG. 3, which transfers program control to operation box 216. At operation box 216, the screen shot depicted in FIG. 3(L) is presented to the farmer. FIG. 3(L) schematically depicts the pocket computer 38 displaying a sample notes-viewer screen according to the present invention.

The sample “Notes Viewer” screen shot depicted in FIG. 3(L) presents four notes 218 at a time to the farmer. Since this aspect of the present invention records location-centric or location-specific information, when the farmer taps on the notes icon 68 depicted in the screen shot of FIG. 3(K), the notes that are presented to the farmer in the “Notes Viewer” depicted in the screen shot of FIG. 3(L) are the notes for this particular operation on this particular field 114. The farmer does not have to sort through a general list of notes, he is immediately presented with only the notes that are relevant to this particular operation on this particular field (i.e., the Rocks field 114). The screen shot depicted in FIG. 3(L) assumes that the farmer has already recorded a first note 220 related to some standing water that the farmer encountered in the Rocks field 114, and the farmer has started a second note 222 that is not yet completed. It is assumed that, upon being presented with the screen shot depicted in FIG. 3(L), the farmer desires to supplement or complete the incomplete second note 222 (i.e., the note presented in the upper right-hand corner of the screen shot depicted in FIG. 3(L)).

To begin revising this second note, the farmer merely taps on the second note 222. This tapping by the farmer on the second note 222 is represented schematically by connector line 224 in FIG. 3 and transfers program control to operation box 226 in that figure. In operation box 226 of FIG. 3, the system presents the farmer with the screen shot depicted in FIG. 3(M). FIG. 3(M) is similar to FIG. 3(L), but it depicts an initial add-note screen shot or edit-note screen shot. At this point, the farmer has a full-screen view of the second note 222, which is now editable. So that the farmer is always certain that he is recording his notes for the correct or appropriate field, the background for the note is the aerial photograph (or other image) of the field (in this case, an aerial photograph of the Rocks field 114). The farmer may then use a finger or stylus to write his note on this background. If the farmer makes a mistake while writing the note, he need merely tap on the “clear” button 228 (FIG. 3(M)) to erase all the notes on the aerial photograph background. The farmer also may be presented with a pen-color palette offering a variety of colors to choose from for making the notes. For example, the farmer may tap on the box 230 to write notes in green, box 232 to write notes in blue, box 234 to write notes in red, box 236 to write notes in white, and/or box 238 to write notes in black. Clearly, the available colors for writing notes may be different from these five colors, and the farmer may use a combination of colors when writing notes.

In the sample screen shots depicted in the figures, it is next assumed that the farmer has edited the second note 222 to show that a portion of his field was “too muddy” to be tilled. This “editing” is represented by connector line 240 in FIG. 3 and transfers control to operation box 242 (FIG. 3). In particular, as shown in the sample screen shot of FIG. 3(N), the farmer has thus written “Too Muddy” on the screen and has colored a portion 244 of the field that was too muddy. Once the farmer has completed his edits to this note 222, he taps on the “DONE” button 92. This tapping on the “DONE” 92 button in FIG. 3(N) is represented schematically by connector 246 in FIG. 3 and transfers program control to operation box 248 in FIG. 3.

In operation box 248, the system presents the farmer with the screen shot depicted in FIG. 3(O). FIG. 3(O) is similar to FIG. 3(L), but it depicts the notes-viewer screen with updated note information. In particular, comparing the screen shot of FIG. 3(L) with the screen shot of FIG. 3(O), it is clearly apparent that the system has now recorded the edits to the second note 222. If the farmer wanted to then create a third note, he could either tap on the “blank” or “empty” note 250 of the lower left-hand corner of FIG. 3(O), or he could tap on the “new note” button 252 depicted on that figure. Further, if more than four notes were present for this particular operation on this particular field, the farmer could view these additional notes by tapping on the “NEXT 4” button 254 depicted in FIG. 3(O). Once the farmer is done creating notes for this particular operation on this particular field, the farmer would tap on the “DONE” button 92 depicted in FIG. 3(O). This tapping by the farmer on the “DONE” button 92 in FIG. 3(O) is represented schematically by the connector line 256 in FIG. 3 and transfers program control to operation box 258. In operation box 258 (FIG. 3), the system presents the farmer again with the screen shot depicted in FIG. 3(K).

At this point in the sample progression, it is assumed that the farmer has made all of the farmer's selections and notes for the tillage operation, so the farmer taps the “DONE” button 92 (FIG. 3(K)), which records the data for the tillage operation. This tapping of the “DONE” button 92 in FIG. 3(K) is represented schematically by the connector line 260 in FIG. 3 and transfers control to operation box 262 in FIG. 3.

At operation box 262, the farmer is presented with the “tap operation” screen depicted in FIG. 3(P). The screen shot depicted in FIG. 3(P) is similar to the screen shot depicted in FIG. 2(H), but depicts altered date and time values. In the screen shot of FIG. 3(P), the date and time shown still reflect the values set by the farmer when he was presented with the screen shots of FIGS. 3(H) and 3(J).

In the screen shot of FIG. 3(P), an aerial photograph of the “Rocks” field 114 is still shown in the background of the “Tap Operation” screen. If the farmer wanted to record information for an additional operation on this particular field, he would make that selection by tapping on one of the icons 124, 126, 128, 130, 132, 134 depicted in the screen shot of FIG. 3(P). For our sample progression, however, it is assumed that the farmer does not want to record an additional operation on this particular field. Rather, it is assumed that the farmer now desires to record a tillage operation on a different field.

In order to change the field for which operation data is to be recorded, the farmer taps on the “DONE” button 92 in the screen shot depicted in FIG. 3(P). This tapping on the “DONE” button in FIG. 3(P) is represented schematically by the connector 264 in FIG. 3 and transfers control to operation box 266 in FIG. 3. In operation box 266, the farmer is presented with the “Tap Field” screen depicted in FIG. 3(Q). The screen shot of FIG. 3(Q) is similar to the screen shot of FIG. 2(G), but depicts different date and time values. Again, as previously stated, tapping the “DONE” button 92 on screens takes the farmer back to a previous screen (represented by a leftward movement in, for example, FIGS. 2 and 3).

When presented with the screen shot of FIG. 3(Q), the farmer is assumed to select the Sanger field 116 by tapping on that field. This tapping on the Sanger field 116 is represented schematically in FIG. 3 by connector 268, which transfers program control to operation box 270. In operation box 270, the farmer is presented with the screen shot depicted in FIG. 3(R). The screen shot of FIG. 3(R) is similar to the screen shots depicted in FIGS. 2(H) and 3(P). However, in the screen shot depicted in FIG. 3(R), an aerial photograph of the Sanger field 116 now appears in the background since the farmer has selected that field as the field on which the next operation is to be recorded.

From the screen shot of FIG. 3(R), it is assumed that the farmer again wants to record a tillage operation. The farmer makes that selection by tapping on the tillage icon 124 shown in FIG. 3(R). This tapping on the tillage icon 124 of FIG. 3(R) is represented schematically by the connector line 272 in FIG. 3 and transfers program control to operation box 274 of FIG. 3. In operation box 274, the farmer is presented with the screen shot of FIG. 3(S). FIG. 3(S) is similar to the screen shots depicted in FIGS. 3(A), 3(C), 3(E), 3(G), 3(I), and 3(K). In FIG. 3(S), however, an aerial photograph of the Sanger field 116 appears in the background so that the farmer has no doubt the field for which he is about to record a tillage operation.

As shown in FIG. 3(S), the selected tractor is the MX180, the selected tool is the chisel, and the selected depth is 6″. It will be noted that these are the same parameters last selected by the farmer in connection with the immediately-prior tillage operation on the Rocks field 114 (see, e.g., the screen shots of FIGS. 3(I) and 3(K)). Since it is frequently the case that a farmer will use the same equipment configuration to till a second field after completing the tillage of a first field, the system sets the default tractor, tool, and depth configuration to what the farmer most recently used for this operation on the first field. Since a farmer will typically leave his equipment as configured for a first field when tilling other fields, this saves entry time on the pocket computer 38 for the farmer by assuming that he will, in fact, keep his equipment configured the same for a subsequent operation that is the same as the previously-performed operation. If, when presented with the screen shot of FIG. 3(R), the farmer had selected an operation other than tillage (i.e., if the farmer selected other than icon 124), he may be presented with a different configuration for his tractor, tool, etc.

In our sample, it is assumed that, when presented with the screen shot of FIG. 3(S), the farmer is satisfied with all of the parameters. Thus, to actually record the tillage operation for the Sanger field 116 using this equipment and settings, the farmer would merely need to tap on the “DONE” button 92. Tapping on the “DONE” button 92 in FIG. 3(S) is represented schematically by connector line 276 in FIG. 3, which transfers control to operation box 278 of FIG. 3. In operation box 278, the screen shot of FIG. 3(R) is again presented to the farmer after the tillage operation is recorded.

It should be noted, that although the system defaults to the settings (e.g., tractor, tool, and depth) most recently used by the farmer for the same type of operation, the “notes” are field specific. Thus, for example, if the farmer were to tap on the notes icon 68 in the screen shot depicted in FIG. 3(S), the farmer would be presented with a different set of notes from those displayed in, for example, FIG. 3(O) since the notes depicted in FIG. 3(O) relate to the “Rocks” field 114 and the farmer is now working the Sanger field 116.

It should also be noted that, if the farmer, while working the Sanger field 116, for example, saw something that he wanted to record photographically, the farmer would merely need to tap on the pictures icon 70 from the screen shot of FIG. 3(S). By tapping on the pictures icon 70 shown in FIG. 3(S), the farmer would be able to use the pocket computer 38 to take a picture, as explained further below in connection with FIGS. 11(A) and 11(B). Upon tapping the pictures icon 70 in FIG. 3(S), the farmer would be initially presented with thumbnail images 280 (FIG. 11(A)) of any previously-taken picture or pictures, and the farmer would have an opportunity to take additional pictures. Again, this is explained further below in connection with the discussion of FIGS. 11(A) and 11(B).

Thus, operation boxes 136, 150, 156, 162, 170, 176, 184, 190, 200, 206, 212, 216, 226, 242, 248, and 258 together with connector lines 148, 154, 160, 168, 174, 182, 188, 198, 204, 210, 214, 224, 240, 246, 256, and 260 of FIG. 3 represent a sample progression of screen shots presented to a farmer to record a tillage operation on a first field. Similarly, operation boxes 262, 266, 270, 274, and 278, together with connector lines 264, 268, 272, and 276 of FIG. 3 represent recording of a tillage operation on a second field (e.g., the Sanger field 116) using the same equipment and settings that were used when recording the tillage operation on the first field (e.g., the Rocks field 114).

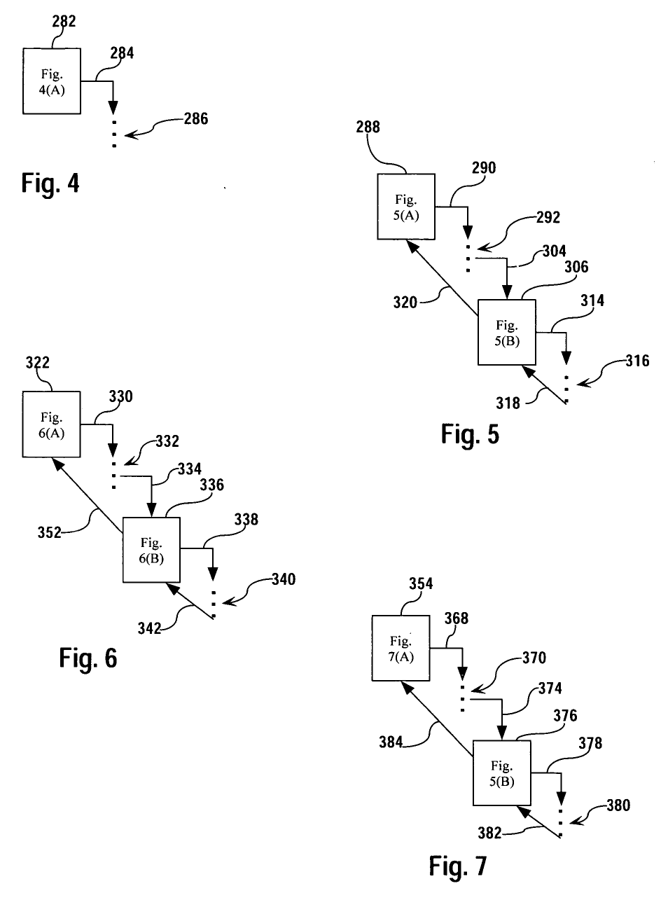

FIGS. 4-7 all assume that a farmer has selected a corresponding operation from a “Tap Operation” screen (see, e.g., FIGS. 2(H), 3(P), or 3(R)). For example, FIG. 4 is an abbreviated flow diagram of a planting operation assuming that the farmer has started from a “Tap Operation” screen. In other words, prior to reaching operation box 282 of FIG. 4, the farmer may have already progressed through the entire flow diagram of FIG. 2 and may have been presented with the screen shot of FIG. 2(H). Rather than tapping the tillage icon 124 as previously discussed in connection with FIG. 3, however, the farmer has tapped the planting icon 126 in FIG. 2(H) and has thus been presented with the screen shot of FIG. 4(A). FIG. 4(A) is similar to FIG. 3(K), but depicts a sample screen for setting planting options. Thus, the planting operation for which the farmer is about to record data via the screen shot depicted in FIG. 4(A) is back on the Rocks field 114, which is apparent from the aerial photograph of the Rocks field 114 appearing in the background of the screen shot of FIG. 4(A).

From the screen shot of FIG. 4(A), the farmer is again able to make appropriate equipment and other selections by tapping on the icons or virtual buttons presented on the screen shot of FIG. 4(A). The program logic for making these selections would be similar to that presented schematically in FIG. 3. Further, the screens presented to the farmer for selection of these options would be similar to the screen shots depicted in FIGS. 3(A) through 3(S). The connector line 284 and the vertically-oriented ellipse 286 in FIG. 4 thus represent the selection of equipment and other options for a planting operation similar to what is presented in FIG. 3.

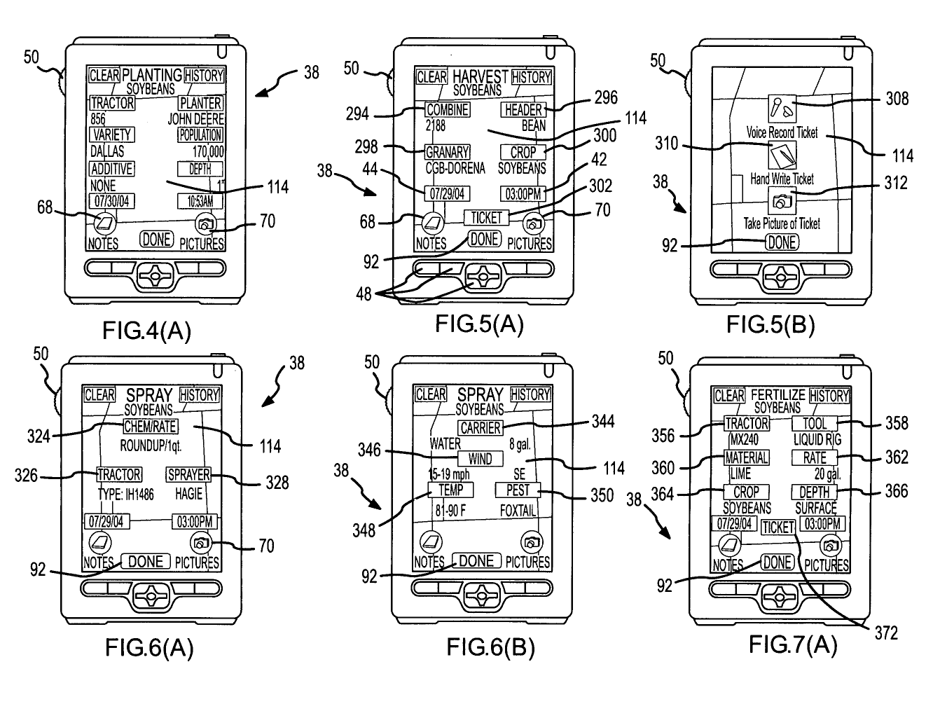

FIG. 5 is similar to FIG. 4, but represents an abbreviated flow diagram for a harvesting operation. Again, the process depicted in FIG. 5 assumes that the farmer has started from the screen shot depicted in, for example, FIG. 2(H) and has selected the harvest icon 128. Upon selection of the harvest icon 128 in the screen shot of FIG. 2(H), control would be transferred to operation box 288 of FIG. 5, and the farmer would be presented with the screen shot of FIG. 5(A). FIG. 5(A) is similar to FIG. 4(A), but depicts a sample screen for setting harvest options. The first connector line 290 and the first vertically-oriented ellipse 292 in the abbreviated flow chart of FIG. 5 again represent the farmer's selection of equipment and other options by tapping on the virtual buttons of FIG. 5(A) (e.g., 294, 296, 298, 300), a process that is analogous to the steps represented by the flow diagram of FIG. 3.

After the farmer has made all of the appropriate selections for the combine (via virtual button 294), header (via virtual button 296), granary (via virtual button 298), crop (via virtual button 300), date (via virtual button 44), and time (via virtual button 42), and after the farmer has made any appropriate notes or taken any desired pictures, he is ready to record a grain ticket.

A grain ticket represents the farmer's production and is the receipt upon which the farmer is paid. When the farmer taps on the virtual ticket button 302 in the screen shot of FIG. 5(A) (an operation represented schematically by connector 304 in FIG. 5), program control is transferred to operation box 306 in FIG. 5. At operation box 306 in FIG. 5, the farmer is presented with the screen shot depicted in FIG. 5(B). By the screen shot depicted in FIG. 5(B), the farmer is presented with three options for making his grain ticket of record. By tapping on the “Voice Record Ticket” icon 308 the farmer is able to read information about the grain ticket to the pocket computer 38. In particular, the pocket computer 38 may comprise a built-in microphone into which the farmer would speak information about the grain ticket. The spoken information would then be recorded by the handheld unit or pocket computer 38 in connection with the harvest operation. The special data handler 32 may subsequently be called upon to transcribe this recorded oral information into searchable text. If, on the other hand, a farmer were to tap on the “Hand Write Ticket” icon 310 depicted in the screen shot of FIG. 5(B), the farmer would be presented with a “Virtual Grain Ticket” on which the farmer could transfer information from the actual, physical grain ticket using, for example, a stylus. The special data handler 32 may subsequently be called upon to convert this recorded hand-entered information into searchable text. The third option presented to the farmer in the screen shot of FIG. 5(B) is an option to tap on the “Take Picture of Ticket” icon 312. If the farmer were to select this third option, he would then be able to take a photograph of the actual, physical grain ticket using a built-in camera comprising part of the pocket computer 38. The process for taking photographs is discussed further below in connection with FIGS. 11(A) and 11(B). The special data handler 32 may subsequently be called upon to convert this recorded photographic information into searchable text.

The farmer's tapping on one of the grain ticket recording option virtual buttons 308, 310, 312 depicted in the screen shot of FIG. 5(B) is represented schematically by the connector line 314 in FIG. 5. The second vertically-oriented ellipse 316 and the connector line 318 in FIG. 5 represents the just-described process of recording information about the grain ticket using one of the three available options. At this point, the program logic has returned to operation box 306 (FIG. 5), whereby the program logic again presents the screen shot depicted in FIG. 5(B) to the farmer.

Once the farmer has recorded information concerning the grain ticket using one of the options depicted in the screen shot of FIG. 5(B) (i.e., using one of virtual buttons 308, 310, 312), the farmer would then tap on the “DONE” button 92 shown on FIG. 5(B), thereby returning the farmer to the screen shot of FIG. 5(A). This tapping operation is represented by a connector 320 depicted in FIG. 5.

FIG. 6 is an abbreviated flow diagram for recording information concerning a spraying operation. Again, for simplicity, the flow diagram of FIG. 6 assumes that the farmer has started from a screen shot like that depicted in FIG. 2(H), and the farmer has already tapped the spraying icon 130. After the farmer taps the spraying icon 130 on the “Tap Operation” screen of, for example, FIG. 2(H), program control transfers to operation box 322 of FIG. 6. In operation box 322 of FIG. 6, the system displays the screen shot depicted in FIG. 6(A). FIG. 6(A) is similar to FIG. 4(A), but depicts a first sample screen for setting options for a spraying operation. From the screen shot depicted in FIG. 6(A), the farmer is able to record relevant information about the chemical being used during the spraying and the rate of delivery of that chemical (via the virtual “CHEM/RATE” button 324), the tractor (via the virtual “TRACTOR” button 326), and the sprayer (via the virtual “SPRAYER” button 328). This selection process is represented schematically by the connector 330 and vertically-oriented ellipse 332 depicted in FIG. 6. The steps and screens for making these appropriate selections would be similar to those screens depicted in, for example, FIGS. 3(B), 3(F), 3(H), 3(J), and 3(L)-3(O), which were previously discussed. The rate information provided on the screen shot of FIG. 6(A) is presented per the farmer's requested format. For example, the noted “CHEM/RATE” of “ROUNDUP/1 qt.” shown in FIG. 6(A) indicates that Roundup® was delivered at a rate of 1 quart per acre.

After the farmer has made all of the appropriate or desired selections of the parameters displayed in FIG. 6(A), the farmer would tap on the “DONE” button 92 in that figure. This tapping on the “DONE” button in the screen shot of FIG. 6(A), is represented schematically by the connector line 334 of FIG. 6 and transfers program control to operation box 336 in FIG. 6. In operation box 336 of FIG. 6, the screen shot depicted in FIG. 6(B) is presented to the farmer. FIG. 6(B) is similar to FIG. 6(A), but depicts a second sample screen for setting options for the spraying operation. When presented with the screen shot of FIG. 6(B), a farmer is able to make the final parameter selections for the spraying operation. This selection of the final parameters for this spraying operation is represented schematically by the connector line 338, the second vertically-oriented ellipse 340, and the connector line 342 of FIG. 6. Again, when selecting the “CARRIER” (via virtual button 344), “WIND” (via virtual button 346), “TEMPERATURE” (via virtual button 348), and “PEST” (via virtual button 350) parameters noted on the screen shot of FIG. 6(B), the farmer is presented with selection screens similar to those depicted in FIGS. 3(B), 3(D), and 3(F).

Once the farmer has selected all of the appropriate parameters on this second screen, the farmer taps on the “DONE” button 92 (FIG. 6(B)). This tapping on the “DONE” button 92 of FIG. 6(B) is represented schematically by the connector 352 in FIG. 6 and transfers control back to operation box 322 of FIG. 6, which again displays the screen shot of FIG. 6(A) to the farmer. If the farmer is then satisfied that all appropriate parameters have been selected, the farmer then taps on the “DONE” button 92 of FIG. 6(A), which would result in the information for the spraying operation being recorded for the field depicted in the background, and would return program control to the logic that presents the screen shot of, for example, FIG. 2(H) to the farmer.

The amount of data that must be collected for EPA compliance is a major driving factor for the information collected in the screens of FIGS. 6(A) and 6(B). Thus, since the recordation of information related to spraying operations is rather complex in view of the farmer's requirement to keep track of the number of parameters, there are two screens for making all of the appropriate selections for a spraying operation.

FIG. 7 is an abbreviated flow diagram of the recordation of a representative fertilizing operation. Again, as was the case with the planting, harvesting, and spraying operations represented schematically in FIGS. 4-6, respectively, the abbreviated flow diagram of FIG. 7 assumes that the farmer, having been presented with a “Tap Operation” screen similar to that depicted in, for example, FIG. 2(H) has selected the fertilizing icon 132.

Upon the farmer's selection of the fertilizing icon 132 in FIG. 2(H), program control is transferred to operation box 354 depicted in FIG. 7. In operation box 354 the system displays, for example, the screen shot depicted in FIG. 7(A). FIG. 7(A) is similar to FIG. 4(A), but depicts a sample screen for setting options for a fertilizing operation. When presented with the screen shot of FIG. 7(A), the farmer is able to select all of the appropriate parameters by tapping on the tractor-selection virtual button 356, the tool-selection virtual button 358, the material-selection virtual button 360, the rate-selection virtual button 362, the crop-selection virtual button 364, and the depth-selection virtual button 366. The selection of these various parameters is represented schematically in the abbreviated flow diagram of FIG. 7 by connector line 368 and first vertically-oriented ellipse 370. The screens presented to the farmer during selection of these various parameters for a fertilizing operation would be similar to the screen shots depicted in, for example, FIGS. 3(B), 3(D), and 3(F).

If the farmer needs to record ticket information related to the fertilizing operation, the farmer would tap on the virtual “TICKET” button 372 shown in FIG. 7(A). This tapping by the farmer on the virtual “ticket” button 372 of FIG. 7(A) is represented by connector line 374 of FIG. 7 and transfers program control to operation box 376. In operation box 376, a screen shot like the one depicted in FIG. 5(B), for example, is displayed to the farmer. The operation of this screen for recording ticket information was described above. The process for recording ticket information for a fertilizing operation is similar to the process for recording grain ticket information, which is discussed above, but the farmer pays off the tickets related to the fertilizing operation. The steps for recording the fertilizer ticket information is represented schematically by the connector 378, the second vertically-oriented ellipse 380, and a connector line 382 of FIG. 7, which returns the program to operation box 376, whereby the program logic again presents the screen shot depicted in FIG. 5(B) to the farmer. When the appropriate ticket information has been recorded, the farmer taps on the “DONE” button 92 (FIG. 5(B)). This tapping on the “DONE” button is represented by the connector line 384 in FIG. 7 and returns program control to operation box 354 in FIG. 7. Operation box 354 again displays the screen shot of FIG. 7(A) to the farmer. At this point, the farmer has set all of the parameters for the fertilization operation and the associated ticket. To record this information, the farmer taps on the “DONE” button 92 (FIG. 7(A)). Tapping on this “DONE” button 92 results in recordation of the corresponding information for the fertilization operation (after the farmer confirms that information for the operation is to be recorded) and results in a screen similar to that depicted in FIG. 2(H), for example, being displayed to the farmer.

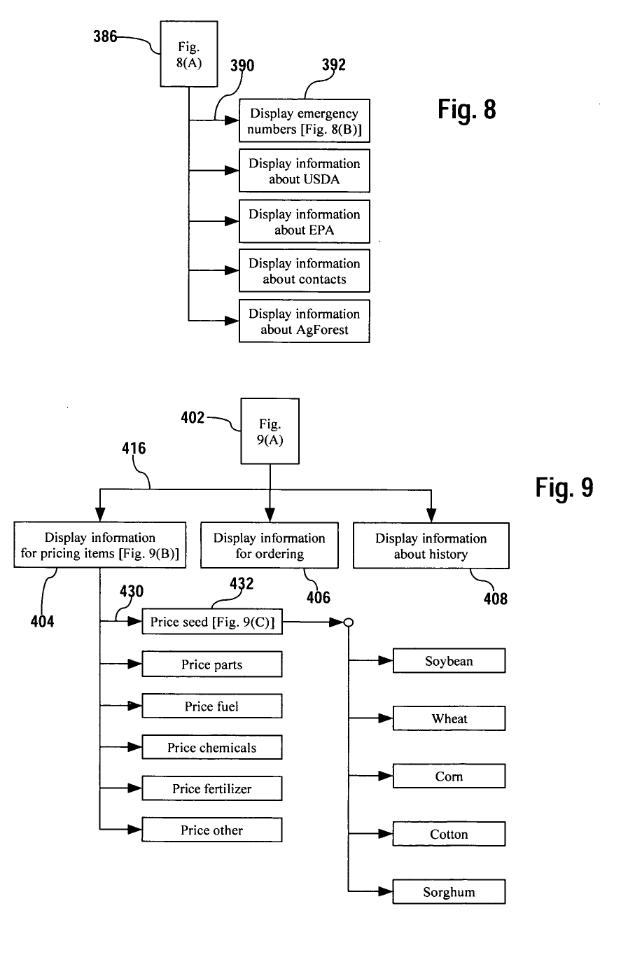

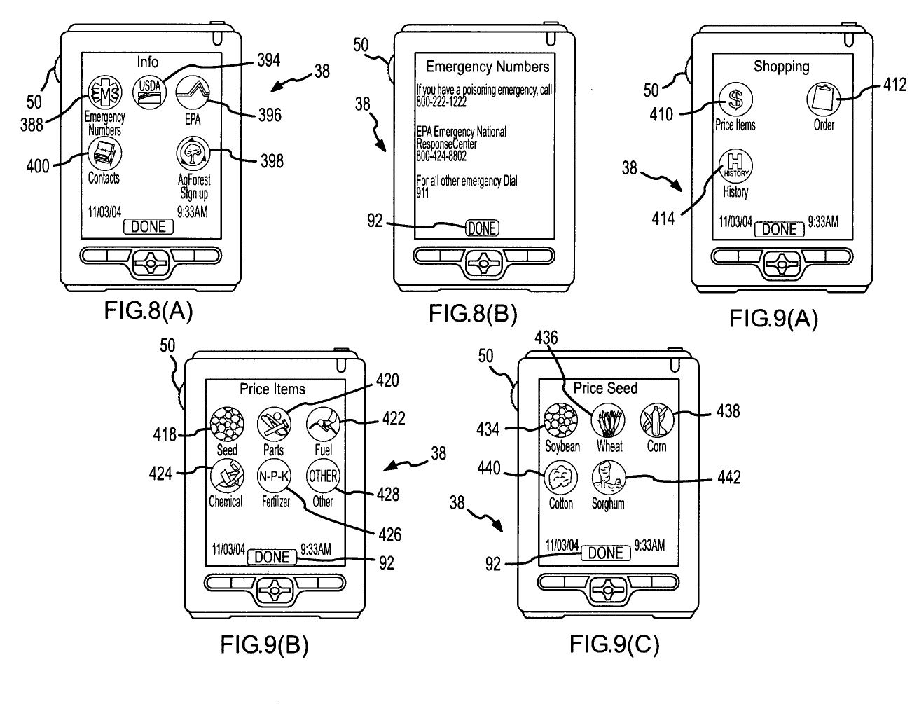

Referring next to FIG. 8, the handheld unit's ability to store and retrieve additional information important to the user of the handheld unit is described next. If, upon being presented with a screen shot of FIG. 2(B), for example, the farmer were to tap on the information icon 60, program control would be transferred to operation box 386 of FIG. 8. FIG. 8 is a diagram that schematically represents how the information screens according to an embodiment of the present invention may be presented. At this point, the screen shot of FIG. 8(A) is presented to the farmer. FIG. 8(A) depicts a first sample information screen. The amount and type of information presented to the farmer on FIG. 8(A) is completely configurable by the farmer. For example, the farmer may want to have emergency numbers readily available.

If the farmer were to tap on the emergency numbers icon 388 in FIG. 8(A), for example, an operation that is represented by connector 390 in FIG. 8, program control would transfer to operation box 392 (FIG. 8). At this point, the farmer would be presented with whatever emergency numbers he has stored. FIG. 8(B) displays a sample screen shot that may be presented to the farmer upon tapping the emergency numbers icon 388 of FIG. 8(A). Once the farmer is finished looking at the emergency numbers, the farmer would merely tap on the “DONE” button 92 of FIG. 8(B), which would return him to the screen shot depicted in FIG. 8(A).

In the screen shot of FIG. 8(A), the farmer has also made available information concerning various government agencies with whom the farmer must deal (e.g., United States Department of Agricultural via icon 394 and the EPA via icon 396), private companies with whom the farmer deals (e.g., AgForest via icon 398), and the other contact information that the farmer wants to have with him via icon 400. By tapping on any of these other icons 394, 396, 398, 400, the farmer would be presented with screens through which the farmer could obtain the desired information. The pocket computer 38 could even be configured with a built-in telephone so that the farmer could directly contact various parties using the pocket computer 38 after navigating to a desired contact.

FIG. 9 schematically represents program logic for carrying out shopping-related operations and graphically presents how the shopping screens according to an embodiment of the present invention may be presented. In particular, if a farmer, presented with the screen shot of FIG. 2(B), taps on the shopping icon 64, program control would be transferred to operation box 402 of FIG. 9 and, at this operation box, the screen shot of FIG. 9(A) would be presented to the farmer. FIG. 9(A) is similar to FIG. 8(A), but depicts an initial shopping screen. The three options presented to the farmer in the screen shot of FIG. 9(A) are represented schematically by operation boxes 404, 406, 408 of FIG. 9. In particular, the farmer when presented with the screen shot of FIG. 9(A), has the option to tap on the “Price Items” icon 410, the “Order” icon 412, or the “History” icon 414.

The farmer may, for example, tap on the “Price Items” icon 410 depicted in FIG. 9(A). This tapping is represented schematically by connector 416 in FIG. 9 and transfers program control to operation box 404. At operation box 404 of FIG. 9, a farmer is presented with the “Price Items” screen shot of FIG. 9(B). FIG. 9(B) is similar to FIG. 9(A), but depicts a sample price-items screen. In the screen shot of FIG. 9(B), the farmer is presented with a variety of groups or classes of items for which the farmer may want to check prices. In particular, in the sample represented by FIG. 9(B), the farmer has the opportunity to price seeds by tapping on the “Seed” icon 418, to price parts by tapping on the “Parts” icon 420, to price fuel by tapping on the “Fuel” icon 422, to price chemicals by tapping on the “Chemical” icon 424, to price fertilizer by tapping on the “Fertilizer” icon 426, and to price any other items of interest by tapping on the “Other” icon 428.

Clearly, the portion of the system that was just described presents partnering and advertising opportunities. For example, when the farmer selects the “Seed” icon 418, the farmer may be presented with advertising or other information related to a particular supplier of seeds who may have compensated the purveyor of the present system for the opportunity to present such information to the farmer. Similarly, if the farmer ultimately decides to purchase items via one of these screens, the special data handler (represented by the icon 32 in FIG. 1) is able to complete the order for the farmer, to deliver certain information about the order to a variety of different parties with a need to know information about the order (e.g., in the case of a sale of seeds, the special data handler 32 may send different pieces of information about the sale to the farmer, to the involved seed seller, to the seed company from whom the seed seller gets seeds, and to the company who may have contributed additives to the seeds that were sold), and to arrange for any delivery when information about the farmer's requested purchase is up-linked to the server 24 (FIG. 1).

In the sample screen shots, it is assumed that the farmer tapped on the “Seed” icon 418 in FIG. 9(B). This tapping on the “Seed” icon 418 is represented by connector 430 in FIG. 9. Once the farmer has tapped on this “Seed” icon 418 in FIG. 9(B), program control transfer to operation box 432 in FIG. 9, and the farmer is presented with the screen shot depicted in FIG. 9(C). FIG. 9(C) is similar to FIG. 9(B), but depicts a sample price-seed screen. From the price-seed screen of FIG. 9(C), the farmer would then be able to tap on a particular type of seeds for which the farmer desires pricing information. In the example screen shot of FIG. 9(C), the farmer is given the option to price soybean seeds (via icon 434), wheat seeds (via icon 436), corn seeds (via icon 438), cotton seeds (via icon 440), or sorghum seeds (via icon 442). Again, this presents various partnering and advertising opportunities for the supplier of the pocket computer 38. Once the farmer has completed the desired pricing operation, he can return to the screen shot depicted in FIG. 9(A) by tapping on the “DONE” button 92 in FIG. 9(C) and then the “DONE” button 92 in FIG. 9(B).

From the screen of FIG. 9(A), the farmer may tap on the “Order” icon 412 to place an actual order for the priced items or for other items. Also, the farmer may tap on the “History” icon 414 of FIG. 9(A) to view shopping history information. For example, in view of the large number of purchases that farmers make, the farmer may have a hazy recollection of a prior purchase. By tapping on the “History” icon 414 of FIG. 9(A), the farmer could quickly review recent purchases and refresh the farmer's recollection. The farmer may also want to review purchase history to determine the price previously paid for an item of which the farmer now needs more.

FIG. 10 schematically represents the program logic for identifying various pests, including insects (or other animals); weeds; and fungus. In particular, FIG. 10 is a diagram that schematically represents how the pest-identification screens according to one embodiment of the present invention may be presented to a farmer. The logic of FIG. 10 would be accessed by, for example, tapping on the “Pest ID” icon 66 depicted in FIG. 2(B), which would transfer program control to operation box 444 of FIG. 10. In operation box 444 of FIG. 10, the program logic displays the screen shot depicted in FIG. 10(A) to the farmer. If the farmer has reached the “Pest Identification” screen depicted in FIG. 10(A), the farmer is generally trying to identify some type of unknown pest whether an insect, a weed, or some type of fungus; or the farmer is trying to find information about how to contain, control, or eliminate a known pest.

FIG. 10(A) depicts an alternative handheld unit 38′ displaying a sample pest-identification screen. The pocket computer 38′ depicted in FIG. 10(A) is different from those depicted in, for example, FIGS. 2(A)-9(C). This particular alternative handheld unit 38′ has a detachable camera 446 attached to the top of it rather than having an integrated or built-in camera (or no camera). Also, the control buttons 48′ depicted in the alternative pocket computer embodiment of FIG. 10(A) are slightly different from the control buttons 48 depicted in the other handheld figures.

Upon reaching the screen shot depicted in FIG. 10(A), the farmer is presented with various icons 448, 450, 452 for trying to identify a variety of different pests and related treatment options. Via the screen shot of FIG. 10(A), for example, the farmer may select from an “Insect ID” icon 448, a “Weed ID” icon 450, or a “Fungus ID” icon 452. Upon tapping, for example, the “Insect ID” icon 448 of FIG. 10(A), the farmer would be presented with a list of and/or photographs or images of the insects known to be in the area of the particular farmer's fields. This presentation of insects is represented schematically by connector lines 454, 456, 458 and boxes 460, 462, 464 together with vertically-oriented ellipse 466 of FIG. 10.

If the insect information presented to the farmer does not include the particular insect that the farmer is curious about, the farmer has the option of photographing the insect to be identified, assuming the farmer is able to find one of the insects in the field. If the farmer does take such a photograph of an unknown insect, that photograph gets up-loaded to the server 24 (FIG. 1), and the special data handler 32 receives an indication that the farmer needs the photographed pest identified. Once the special data handler 32 has been able to identify the particular pest about which the farmer wants information, information about that pest and how to control or contain the pest could be sent back to the farmer's pocket computer 38 or 38′ upon a subsequent download of information. The farmer would then receive an indication that he had information available concerning the now-identified pest. As suggested above, information sent back to the farmer could include not only information about the specific pest but also information about how to eliminate or mitigate any ill effects the pest may be causing to the farmer's crops. Again, the system's ability to provide answers to the farmer about pests and possible treatments for the various pests present partnering opportunities with insecticide or fertilizer manufacturers, for example.

During use of the pocket computer 38 described above, the farmer is presented with various opportunities for taking photographs. For example, by tapping on the “TAKE PIC” icon 70 of FIG. 2(B), the farmer may take general pictures. Similarly, by tapping on the camera icon 70 in, for example, FIG. 3(A), the farmer is able to record pictures related to that specific tillage operation. Similarly, the farmer is presented with other opportunities to take pictures in, for examples, FIGS. 5(A) (see icon 70), 5(B) (see icon 312), and 6(A) (see icon 70).

If the farmer elects to take photographs when presented with one of these opportunities by tapping on the “camera” icon, for example, the farmer is presented with a screen shot similar to what is depicted in FIG. 11(A), which is a picture viewer. In particular, the farmer is presented with thumbnail images of any previously-taken pictures that correspond to the particular point in the system from which the farmer taps on the camera icon. Thus, the farmer is not presented with all of the previously-taken pictures, independent of the context in which those pictures were originally taken. Only the pictures that are relevant to the particular point at which the farmer taps on the camera icon are presented.

In the sample screen shots shown in the figures, the farmer is presented with thumbnail images of up to four previously-taken pictures at a time. Referring specifically to the screen shot of FIG. 11(A), the farmer is presented with a single, previously-taken photograph 280. As shown in this single photograph, in the upper left-hand corner of the screen shot depicted in FIG. 11(A), there is a small icon of a notepad and pen 468. If the farmer were to tap on this small notepad icon 468, the farmer would be given the opportunity to associate some notes with the particular picture, similar to writing on the back of a physical picture. If the picture viewer depicted in the screen shot of FIG. 11(A) included more than four pictures, the farmer could view the next four pictures by tapping on the “NEXT 4” button 470 depicted on the screen.

If, on the other hand, the farmer were interested in taking a new picture, he would tap on the “NEW PIC” virtual button 472 on the screen shot of FIG. 11(A). By tapping on this virtual button 472, the farmer is transferred to the screen shot depicted in FIG. 11(B). The screen shot of FIG. 11(B) includes a view finder 474 and a shutter activation button 476. The farmer would frame and focus the item that the farmer wants to photograph using the view finder 474 and possibly the physical buttons 48 on the front surface of the pocket computer 38. The image in the view finder would be recorded upon tapping the “TAKE PIC” button 476 (or, alternatively, one of the physical buttons 48). When the farmer was done taking photographs, he would tap on the “DONE” button 92 in FIG. 11(B), which would return the farmer to the “Picture Viewer” screen shot depicted in, for example, FIG. 11(A). Once the farmer was done taking and viewing pictures, the farmer would tap on the “DONE” button 92 of FIG. 11(A), which would return the farmer to whatever screen the farmer was viewing when he tapped the picture icon (e.g., 70 or 312).

As referred to at various points above, the overall system 10 of the present invention according to an alternative embodiment may further include the Web interface 34 shown in FIG. 1. In this latter embodiment, a farmer may use the Web interface 34 (via the personal computer 35, for example) to configure and/or to reconfigure each handheld unit 12 being used in that farmer's farming operation. Each handheld unit 12 need not be configured identically. When logged into the Web interface 34, the farmer would be presented with screens showing all of the available options, and the farmer could pick and choose which options will be displayed on each handheld unit and the order in which those options will be presented to the handheld unit's user. In this manner, certain recorded information may be visible to, but not changeable by, someone using a first handheld unit, whereas the user of a second handheld unit may be presented with different viewing and recording options. For example, someone responsible only for spraying operations (i.e., the “sprayer”) may be given a handheld unit that only allows the sprayer to record information related to spraying operations. That sprayer may be prevented from seeing and/or overwriting information related to other operations. This feature helps prevent inadvertent overwrite errors since, via the system 10 depicted in FIG. 1, data on each handheld may get periodically synchronized with the data of other handhelds, depending upon how the farmer configures the system. For example, the spraying-related information recorded by one user may eventually be reviewable by a second user with a different handheld unit (e.g., a landlord in a different state). Thus, the system 10 includes features to mitigate opportunities for inadvertent data corruption.

A “boss farmer” with access to the Web interface 34 is able to configure each handheld as desired. Thus, no farmer is stuck with a one-size-fits-all configuration. Rather, the farmer is able to configure his handheld units 12 to emulate that farmer's method or methods of farming. The farmer may select only the data points for which he wants to record information, and he can arrange the presentation of the screens as well as the information on the screens (e.g., the icons) any way desired. If the farmer starts his “farming year” at planting, for example, the planting information may appear first on each screen. Similarly, if the farmer starts his “farming year” immediately after harvesting, the harvesting information may appear first on each screen.

Although several embodiments of this invention have been described above with a certain degree of particularity, those skilled in the art could make numerous alterations to the disclosed embodiments without departing from the spirit or scope of this invention. For example, although particular information is shown and arranged on the screen shots, different information or somewhat different arrangements could be used without departing from the present invention. The present invention provides an extremely simple interface which transcends educational backgrounds, cultural backgrounds, and previous computer experience. The system provides multiple ways of recording data, including, for example, the option to make voice recordings, to make text entries on screens (e.g., screens where a farmer may “type” or handwrite entries on a virtual form displayed by the pocket computer), to make handwritten notes and sketching on aerial photographs of fields, to take photographs, or to telephone a special data handler or other individual. No formal instructions or computer experience are needed to operate the system. A successful user of the system need only be able to recognize simple pictures and icons and a limited number of textural lists in order to be able to keep highly-accurate information concerning various farming and other agricultural operations. No memory-intensive maps or complex mapping capabilities are required. Further, although the invention has been described primarily in the context of tracking data for a farming operation, the system may be used for tracking data in a variety of different environments. All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. It is intended that all matter contained in the above description or shown in the accompanying drawings shall be interpreted as illustrative only and not limiting. Changes in detail or structure may be made without departing from the spirit or scope of the invention as defined in the appended claims.

What is claimed is:

1. A pocket computer for electronically storing farming-related information for a selected field, the pocket computer comprising
a memory for storing said farming-related information; and
a resident computer program to control a graphical user interface that generates a plurality of touchscreens to facilitate receipt and storage of said farming-related information into said memory, wherein said resident computer program is adapted to store said farming-related information based upon user inputs received through said graphical user interface, and wherein at least a subset of said plurality of touchscreens generated by said graphical user interface comprises said farming-related information overlaid onto an aerial photograph of the selected field.

2. The pocket computer of claim 1 further comprising at least one of a camera, a microphone, a keypad, and a telephone.

3. The pocket computer of claim 1, wherein said plurality of touchscreens comprises
(a) a first plurality of touchscreens for recording information related to a tillage operation;
(b) a second plurality of touchscreens for recording information related to a planting operation;
(c) a third plurality of touchscreens for recording information related to a harvesting operation;
(d) a fourth plurality of touchscreens for recording information related to a spraying operation; and
(e) a fifth plurality of touchscreens for recording information related to a fertilizing operation.

4. The pocket computer of claim 1, wherein said plurality of touchscreens comprises
(a) at least one activity touchscreen for selecting a farming-related activity; and
(b) at least one operation touchscreen for selecting a farming-related operation.

5. The pocket computer of claim 4, wherein said at least one operation touchscreen for selecting a farming-related operation comprises selectable icons overlaid on said aerial photograph of the selected field.

6. The pocket computer of claim 4, wherein said at least one activity touchscreen comprises a farming icon and a pest-identification icon.

7. The pocket computer of claim 4, wherein said at least one operation touchscreen comprises a tillage icon, a planting icon, a harvesting icon, a spraying icon, and a fertilizing icon.

8. The pocket computer of claim 4, wherein said at least one activity touchscreen comprises a farming activity icon, and wherein said at least one operation touchscreen comprises at least one farming operation icon selected from the group consisting of a tillage icon, a planting icon, a harvesting icon, a spraying icon, and a fertilizing icon.

9. The pocket computer of claim 8, wherein, upon selection of said at least one farming operation icon, said graphical user interface is adapted to generate at least one additional touchscreen for setting options for the selected farming-related operation.

10. The pocket computer of claim 1, wherein said plurality of touchscreens further comprises
(a) an opening touchscreen;
(b) an activity-selection touchscreen; and
(c) an operation-selection touchscreen comprising at least one farming operation icon overlaid on said aerial photograph of the selected field.

11. The pocket computer of claim 10, wherein said at least one farming operation icon is selected from the group consisting of a tillage icon, a planting icon, a harvest icon, a spraying icon, and a fertilizing icon.

12. The pocket computer of claim 1, wherein said plurality of touchscreens further comprises a tillage touchscreen for recording information related to a tillage operation, said tillage touchscreen comprising
(i) a tractor-selection button;
(ii) a tool-selection button; and
(iii) a depth-selection button.

13. The pocket computer of claim 12, wherein said tillage touchscreen further comprises a date-selection icon and a time-selection icon, said date-selection icon and said time-selection icon facilitating recordation of temporally-shifted information.

14. The pocket computer of claim 12, wherein, upon selection of said tractor-selection button, said graphical user interface is adapted to generate a tractor-selection touchscreen comprising a context-sensitive list of user-selectable tractors available for said tillage operation.

15. The pocket computer of claim 12, wherein, upon selection of said tool-selection button, said graphical user interface is adapted to generate a tool-selection touchscreen comprising a context-sensitive list of user-selectable tools available for said tillage operation.

16. The pocket computer of claim 12, wherein, upon selection of said depth-selection button, said graphical user interface is adapted to generate a depth-selection touchscreen comprising a context-sensitive list of user-selectable depths for said tillage operation.

17. The pocket computer of claim 1, wherein said plurality of touchscreens further comprises an activity-selection touchscreen including a pest-identification icon.

18. The pocket computer of claim 17, wherein said graphical user interface is adapted to generate, upon selection of said pest-identification icon, a further plurality of touchscreens that facilitate identification of pests.

19. The pocket computer of claim 18 further comprising a camera for recording visual observations, wherein said camera is adapted for photographing pests to be identified.

20. The pocket computer of claim 19, wherein said resident computer program is adapted to generate, upon use of said camera to photograph an unidentified pest to be identified, an inquiry message for automatic delivery to a special data handler.

21. The pocket computer of claim 18 further comprising a camera for recording visual observations, and wherein said plurality of touchscreens that facilitate identification of pests further comprises touchscreens for completing at least one of (a) recording a written description of an unidentified pest, (2) recording a spoken description of said unidentified pest, and (3) recording a photograph of said unidentified pest.

22. The pocket computer of claim 18, wherein said plurality of touchscreens that facilitate identification of pests comprises a first pest-identification touchscreen that includes at least one of (i) an insect-identification icon, (ii) a weed-identification icon, and (iii) a fungus-identification icon.

23. The pocket computer of claim 22, wherein said graphical user interface is adapted to present, upon selection of said pest-identification icon, a pest-identification touchscreen comprising an image of at least one insect.

24. The pocket computer of claim 1, wherein said plurality of touchscreens further comprises an activity-selection touchscreen including a shopping icon.

25. The pocket computer of claim 24, wherein said graphical user interface is adapted to generate, upon selection of said shopping icon, a plurality of touchscreens that facilitate shopping including at least one of (i) a price-items touchscreen and (ii) a price-seed touchscreen.

26. The pocket computer of claim 24, wherein said graphical user interface is adapted to generate, upon selection of said shopping icon, a touchscreen including a price-seed icon, and wherein said graphical user interface is adapted to generate, upon selection of said price-seed icon, a touchscreen comprising at least one icon selected from the group consisting of a soybean seeds icon, a wheat seeds icon, a corn seeds icon, a cotton seeds icon, and a sorghum seeds icon.

27. The pocket computer of claim 24, wherein said graphical user interface is adapted to generate, upon selection of said shopping icon, a touchscreen including a price-items icon, and wherein said graphical user interface is adapted to generate, upon selection of said price-items icon, a touchscreen comprising at least one icon selected from the group consisting of a seed icon, a parts icon, a fuel icon, a chemical icon, and a fertilizer icon.

28. The pocket computer of claim 24, wherein said graphical user interface is adapted to generate, upon selection of said shopping icon, a touchscreen including an order-items icon, and wherein said resident computer program is adapted to generate, upon selection of said order-items icon, an order message for automatic delivery to a special data handler.

29. The pocket computer of claim 1, wherein said plurality of touchscreens further comprises a record-ticket-information icon, and wherein said graphical user interface is adapted to generate, upon selection of said record-ticket-information icon, a plurality of touchscreens that facilitate recording of information related to a paper grain ticket.

30. The pocket computer of claim 29, wherein said plurality of touchscreens that facilitate recording of information related to said paper grain ticket include a voice-record-ticket icon, a hand-write-ticket icon, and a take-picture-of-ticket icon.

31. The pocket computer of claim 30, wherein, upon selection of said voice-record-ticket icon, said resident computer program activates a built-in microphone for recording spoken information about said paper grain ticket.

32. The pocket computer of claim 30, wherein, upon selection of said hand-write-ticket icon, said graphical user interface generates a virtual-grain-ticket screen on which information about said paper grain ticket may be recorded.

33. The pocket computer of claim 30, wherein, upon selection of said take-picture-of-ticket icon, said graphical user interface presents photograph-taking touchscreens via which an uploadable photograph of said paper grain ticket may be recorded.

34. A handheld device for electronically storing and processing task-specific data for a particular task, the handheld device comprising
a memory for storing said task-specific data; and
a resident computer program to control a graphical user interface that generates a plurality of touchscreens to facilitate receipt and storage of said task-specific data into said memory, wherein said resident computer program is adapted to store and manipulate said task-specific data based upon user inputs received through said graphical user interface, and wherein said graphical user interface presents a notes icon for accessing note-taking capabilities.

35. A handheld device for electronically storing data for a point-of-origin, the handheld device comprising
a memory for storing said data; and
a resident computer program to control a graphical user interface that generates a plurality of touchscreens to facilitate receipt and storage of said data into said memory, wherein said resident computer program is adapted to store and manipulate said data based upon user inputs received through said graphical user interface, and wherein said graphical user interface presents a plurality of touchscreens for creating and storing notes specific to the point-of-origin.

36. The handheld device of claim 35, wherein said plurality of touchscreens for creating and storing notes specific to the point-of-origin comprises a first notes touchscreen including a user-selectable notes icon for displaying a notes-viewer touchscreen for reviewing previously-stored, point-of-origin-specific notes and for creating and storing new point-of-origin-specific notes.

37. The handheld device of claim 36, wherein said notes-viewer touchscreen is adapted to display at least one previously-stored, point-of-origin-specific note, and wherein said notes-viewer touchscreen further comprises a new-note active region.

38. The handheld device of claim 37, wherein, upon user contact with said new-note active region of said notes-viewer touchscreen, said graphical user interface generates a new-note touchscreen including a note-receiving region.

39. The handheld device of claim 38, wherein said point-of-origin is a selected field, and wherein said graphical user interface presents said note-receiving region overlaid onto an aerial photograph of said selected field.

40. The handheld device of claim 38, wherein, upon contact with said new-note active region of said notes-viewer touchscreen, said graphical user interface generates a pen-color palette that includes a plurality of user-selectable color option for taking notes.

41. A system for electronically recording and processing agricultural and other farming-related data for a selected farm, the system comprising
a mobile device with a touchscreen display for recording data, wherein said mobile device is adapted to be carried by an operator conducting farming-related activities;
a service network including a special data handler adapted to perform various back-office functions including addressing operator-originated inquiries and preparing operator-requested reports based upon said agricultural and other farming-related data; and
a data link for connecting said mobile device with said service network to facilitate the selective exchange of data between said mobile device and said service network.

42. The system of claim 41, wherein said service network and said special data handler are each physically located remotely from said selected farm.

43. The system of claim 42, wherein said service network comprises a remote server and wherein said special data handler comprises personnel and equipment adapted to communicate with said mobile device.

44. The system of claim 41, wherein said data link comprises a wireless hotspot located on said selected farm, and wherein said mobile device is configured to automatically and wirelessly exchange said agricultural and other farming-related data with said service network.

45. A method for electronically storing and manipulating field-specific farming information using a handheld computer having a graphical user interface presented on a touchscreen display, the method comprising
said graphical user interface serially generating on said touchscreen display, in response to a farmer selectively touching said touchscreen display, the following touchscreens:
(a) an opening touchscreen;
(b) an activity-selection touchscreen; and
(c) an operation-selection touchscreen having as a background an image of a farmer-selected field for which farming information is to be collected.

46. The method of claim 45, wherein said generating step further comprises said graphical user interface generating at least one option-selection touchscreen selected from the group consisting of (i) a tractor selection touchscreen; (ii) a combine selection touchscreen, (iii) a header selection touchscreen, (iv) a sprayer selection touchscreen; (v) a chemical selection touchscreen; (vi) a rate-of-delivery selection touchscreen; (vii) a carrier selection touchscreen; (viii) a wind speed entry touchscreen; (ix) a temperature entry touchscreen; (x) a pest-to-be-treated selection touchscreen; (xi) a depth selection touchscreen; (xii) a granary selection touchscreen, (xiii) a crop selection touchscreen, and (xiv) a fertilizing material selection touchscreen.

47. The method of claim 45, wherein, between said generation of said activity-selection touchscreen and said generation of said operation-selection touchscreen, said graphical user interface generates at least one of a select-state touchscreen, a select-county touchscreen, a select-farm-group touchscreen, a select-farm touchscreen, and a select-field touchscreen.

48. The method of claim 45, wherein, between said generation of said activity-selection touchscreen and said generation of said operation-selection touchscreen, said graphical user interface generates at least a select-state touchscreen comprising a graphical representation of at least one state in which said farmer conducts farming operations.

49. The method of claim 45, wherein, between said generation of said activity-selection touchscreen and said generation of said operation-selection touchscreen, said graphical user interface generates at least a select-county touchscreen comprising a graphical representation of at least one county in which said farmer conducts farming operations.

50. The method of claim 45, wherein, between said generation of said activity-selection touchscreen and said generation of said operation-selection touchscreen, said graphical user interface generates at least a select-farm-group touchscreen comprising a graphical representation of at least one farm group for which said farmer conducts farming operations.

51. The method of claim 45, wherein, between said generation of said activity-selection touchscreen and said generation of said operation-selection touchscreen, said graphical user interface generates at least a select-farm touchscreen comprising a graphical representation of at least one farm on which the farmer conducts farming operations.

52. The method of claim 45, wherein, between said generation of said activity-selection touchscreen and said generation of said operation-selection touchscreen, said graphical user interface generates at least a select-field touchscreen comprising a graphical representation of at least one field on which the farmer conducts farming operations.

53. The method of claim 48-52, wherein said displaying a graphical representation comprises displaying an aerial photograph.

54. The method of claim 45, wherein said operation-selection touchscreen generated in said generating step further comprises at least one farming-operations icon selected from the group consisting of a tillage icon, a planting icon, a fertilizing icon, a spraying icon, and a harvesting icon.

55. The method of claim 45, wherein said displaying said activity-selection touchscreen step further comprises generating a touchscreen comprising at least one activity icon selected from the group consisting of a farming icon, a shopping icon, and a pest-identification icon.

56. A method for electronically storing and manipulating field-specific farming information for a selected field using a handheld computer having a touchscreen display and a resident computer program controlling a graphical user interface presented on said touchscreen display, the method comprising the steps of
serially presenting to an operator of said handheld computer, upon said operator selectively touching said touchscreen display, a plurality of touchscreens for selecting operation parameters for a farming operation, wherein at least a subset of said plurality of touchscreens presents data overlaid upon an aerial photograph of said selected field; and
enabling exchange of said farming information between said handheld computer and a service network including a special data handler adapted to perform various back-office functions including addressing an operator-originated inquiry and completing an operator-requested project.

57. The method of claim 56, wherein completing said operator-requested project comprises preparing operator-requested reports based upon said field-specific farming information.

58. The method of claim 56, wherein completing said operator-requested project comprises completing a product order.

59. The method of claim 56, wherein said operator-originated inquiry comprises a request to have a photographed pest identified, and wherein said enabling step further comprises (i) automatically delivering a pest photograph taken by the operator to said special data handler for follow-up research, and (ii) conveying a result of said follow-up research to the operator.

60. The method of claim 59, wherein said research result comprises pest identification information and pest control and treatment suggestions.

61. The method of claim 56, wherein said method further comprises facilitating on-the-fly changes to said operation parameters presented on said plurality of touchscreens via wireless data exchanges between said handheld computer and said service network.

62. The method of claim 61, wherein the step of facilitating on-the-fly changes to said operation parameters presented on said plurality of touchscreens for selecting operation parameters further comprises (i) automatically passing a farmer-generated message concerning an equipment change to said special data handler and (ii) downloading change commands to said resident computer program to automatically make corresponding adjustments to touchscreens affected by said equipment change.

63. The method of claim 62, wherein the step of facilitating on-the-fly changes to said operation parameters presented on said plurality of touchscreens for selecting operation parameters further comprises presenting a notes icon used to create said farmer-generated message concerning said equipment change.

64. A method for electronically storing and manipulating field-specific farming information using a handheld computer having a touchscreen display and a resident computer program to control a graphical user interface that generates a plurality of touchscreens on said touchscreen display, the method comprising the steps of
enabling a farmer to select a first set of operating parameters that are pertinent to carrying out a farming operation on a first field by serially presenting to said farmer, upon said farmer selectively touching said touchscreen display, an initial series of touchscreens, wherein said initial series of touchscreens comprises a tractor selection touchscreen and a farming tool selection touchscreen;
storing said first set of operating parameters;
displaying said first set of operating parameters on a touchscreen comprising said first set of operating parameters overlaid upon an image of said first field;
upon said farmer attempting to create a second set of operating parameters pertinent to carrying out said farming operation on a second field, defaulting values for said second set of operating parameters to values of said first set of operating parameters; and
displaying said second set of operating parameters on a touchscreen comprising said second set of operating parameters overlaid upon an image of said second field.
